(19) United States
(12) Patent Application Publication
(10) Pub. No.: US 2007/0156443 A1
(43) Pub. Date: Jul. 5, 2007

(54) Electronic System and Apparatuses Coupling Ticketing on Mobile Devices with Event Sponsorship and Interaction

(76) Inventor: Amy R. Gurvey, Upper Montclair, NJ (US)

Correspondence Address: GOTTLIEB RACKMAN & REISMAN PC, 270 MADISON AVENUE, 8TH FLOOR, NEW YORK, NY, 100160601, US

(21) Appl. No.: 11/612,854

(22) Filed: Dec. 19, 2006

Related U.S. Application Data
(63) Continuation-in-part of application No. 11/253,912, filed on Oct. 18, 2005.
Application No. 11/253,912 is a continuation-in-part of application No. 10/442,468, filed on May 20, 2003.
(60) Provisional application No. 60/382,710, filed on May 22, 2002.
(60) Provisional application No. 60/382,949, filed on May 24, 2002.

(51) Int. Cl. G06Q 99/00

(52) U.S. Cl. 705/1

(57) ABSTRACT

The instant disclosure is a continuation in part of this inventor's previously disclosed US and PCT patent applications that claim operating systems, apparatuses and mobile phone devices for live event and common carrier electronic ticketing, event interaction and the end-to-end production, editing, authenticated distribution and management of event-associated Recordings. It now adds placement of at least one of a logo, message, icon, ad or public service announcement on an electronic ticket, entry pass, admission/placed bet or other receipt and on event-related Recordings as a technological production solution for global brands and program sponsors that is independent of placing ads on search engine Websites and their links.

### RELATED APPLICATIONS

The instant application is a continuation-in-part of application Ser. No. 10/442,468 filed May 20, 2003, Ser. No. 11,253,912 filed Oct. 18, 2005, and PCT Ser. No. 2005/37549 filed Oct. 18, 2005 which claim the benefit of U.S. Provisional Application Nos. 60/382,710 filed May 22, 2002, U.S. Provisional Application No. 60/382,949 filed May 24, 2002, and provisional application Ser. No. 60/619,754 filed Oct. 18, 2004.

### I. DETAILED DESCRIPTION

The present disclosure is a continuation in part of this inventor's issued US Copyright Registrations and pending US and PCT patent applications that claim operating systems and apparatuses for live event and common carrier electronic ticketing (including air travel) and end-to-end production, finance, authenticated distribution and management of event-related “Recordings” as herein defined. It claims the placement of at least one of a program sponsor's logo, icon, message, public service announcement (“PSA”) and advertisement on: (i) an electronic ticket, admission/entry pass, placed bet or other receipt (herein collectively called a “ticket”) regardless of whether (as claimed in this inventor's prior disclosures) that ticket takes the form of a cellular phone, other mobile device [personal digital assistant (herein “PDA”), Blackberry, Treo, Palm, etc.], its assigned electronic identification number (“EIN”), circuitry, call number, information displayed on its screen, user's account, bar code, DNA fingerprint or other uniquely identifying information of a consumer/user; and (ii) “Recordings”, products and services emanating from or associated with the live events, venues or means of travel.

The “events” or “live events” as used herein are defined to mean actual live events, entertainment offerings, endeavors or activities attended by or participated in by live or connected audience spectators (concerts, sports ballgames, stage plays, musicals, showcases, theatrical film screenings, professional, news and educational conferences, seminars, art showings, videogames, competitions, tournaments, etc.); modes of transportation including air travel; events wherein attendance, interaction or participation is by an entity/institution's staff, patrons, subscribers, fans, customers, etc.; and events wherein authorizations or orders to attend, view, listen, interact, participate or buy Recordings are transmitted and/or receipted over wired and wireless networks.

“Recording” or “Live Recording” as used herein (and in this inventor's previous disclosures) is defined to mean any audio, video or audiovisual material, document, file or data based on signals or content emanating, derived from or representative of a live event, activity or any part thereof, or an occurrence pre or post event that is related to it including, without limitation, as it is packaged in whole or in part for sale and distribution in any medium.

Without limitation, “Recordings” may include as examples: audio; music; video; audiovideo; concert feed; recital; screening; film; soundtrack; professional, press, news or educational conference; sports competition (baseball/football game, tennis match, soccer tournament, etc.); musical; stageplay; showcase; presentation; photograph; still; pin-up; autograph; clip; revue; interview; mime production; literary work; reading; theme park amusement; arcade tournament; game; videogame; showing; display; art exhibition; artwork; spoken dialogue; soliloquy; reading'lecture; speech; seminar; class; sermon; compilation; medical record; legal document; court transcript and any event's highlights as edited and packaged in any format for distribution in all media.

Typically, a “Recording” is stored, thereafter balanced, edited or otherwise revised in digital, analog or other format, and/or transmitted by a means of distribution e.g., broadcast signal, radio, over-the-air television, scrambled signal, cable, Internet, podcast, Webcast, satellite, radio broadcast, clipcast, regular mail, hand delivery, wire, cellular/wireless so-called “Wi-Fi”, “Bluetooth”, etc.; or by any other means now known or hereafter devised.

At some time, a “Recording” may become embodied or stored on a fixed, tangible medium of expression such as film, VCR tape, optical disc (CD, DVD, dual disc, etc.), magnetic cassette, reel-to-reel, LP, local or remote hard drive, PC, [portable] music or media player, IPTV device, PDA, Blackberry, Treo, Palm, cellular phone or other storage medium, etc., or alternatively may be received, stored, edited, displayed, distributed, transmitted and re-performed without physical embodiment.

Recordings are receivable in either a fixed medium of expression or unfixed format by a third person, party or entity to include, without limitation, a consumer, purchaser, third-party seller or licensee in analog, digital or other encoded format [digital data (if necessary)] or sub-distributor including Web subscription site. Notwithstanding the foregoing, nothing contained herein is meant to limit the scope of the inventor's claims should other Recording formats or means of delivery be made available in the future.

For purposes of this disclosure, order and retrieval of a Recording may occur on or off site from where an event takes place including, without limitation, on portable personal hand-held devices (cellular phones, hand-held music/media players, PDA's, Blackberrys, Treos, Palms, IPTV devices, etc.); enabled location-based intelligent terminal/kiosk apparatuses (that may include, for example, the inventor's previously claimed enabled turnstiles, audience seats, chairs, hospitality tables and wall kiosks), home terminals (a PC, media player, Web TV, etc.); and/or from a third-party distributor such as a producer, subdistributor, venue, online subscription site or service, Webcaster or podcaster.

To the extent that order and/or retrieval of a Recording is to be over a wire, cable, wireless cellular or any telecommunications network, the instant disclosure is deemed to work with or incorporate any land, mobile, electronic identification number (“EIN”), call (phone) number, IPTV, address, e-mail address, URL, bar code, credit card, DNA fingerprint, social security number, Internet Web, podcast, satellite radio address, other account, or uniquely identifying data of a consumer (for example, information related to order of a ring tome or prior song download from a subscription site) that can assist with authentication or directing transmission of content.

### II. HISTORY OF THE INVENTION

The instant disclosure provides a novel technological solution for producers and global advertisers who are now creating programming for the new line of mobile devices that are also phones. Since the birth of television, global advertisers have been the primary sponsors of commercial network television and syndicated programming distributed free over-the-air and to cable networks. The public's price for the TV programming it has enjoyed free has been to watch the commercials of the sponsors.

Because of recent market penetration of technology that allows consumers to fast-forward through commercials on television sets and the increasing use of the Internet to order content, global brands are now seeking new outlets for their advertising dollars. One outlet is buying ads on search engine Websites and their links. A second (and for which no adequate advertisers'technology solution is yet available) is mobile-delivered programming targeted for initial or ancillary release over wireless networks.

In fact, for the past few years, major brands have been concertedly steering away from investing in sitcoms, dramas and series that have traditionally comprised the bulk of the commercial TV networks'prime time line-up. Instead, they now prefer professional sports and the new trend of reality shows and talent competitions that have a much lower budget and negative cost of production, where new stars, celebrities and products may be borne and viewers have demonstrated a marked preference for watching the programs live as they air. The reason is simple—when viewers tune in to live broadcasts, they cannot fast-forward through the sponsors' commercials.

In the talent competition field, shows like “American Idol” actually offer the sponsor even more “bite for the buck” as a new star becomes a marketable commodity. There has been shown to be a direct positive correlation between the rate at which new talent becomes marketable throughout the world and the proportionate number of votes input for a performer/artist by both the live attending and networked audiences (now primarily through land lines, Internet, PC and cellular phone devices).

Statistics also reveal that “clipeasts” (both audio and audiovideo) of completed live events comprise much of the packaged content currently offered cellular phone subscribers for a fixed price per month (or occasionally free as promos when a sponsors'products are advertised). Examples include sports scores, news headlines and stock quotes. Mobile-aired clips from television network series episodes are now also offered to test if they entice consumers to order full-length episodes for viewing on cellular phones (that are charged at a premium).

These facts notwithstanding, commercial networks and program suppliers have yet to implement a technological solution that enables them to maximize revenues from ancillary wireless mobile delivery of first run programming whether that be taped or live. And there is still no advertising solution for producers and sponsors of other mobile-delivered content like interactive videogames and Chat room contests that are becoming increasingly attractive to the newer social Website companies as more consumers, e-dates and e-friends seek novel ways to participate together on-line.

### III. CELLULAR PROGRAMMING

The cellular phone display is fast becoming the most valuable and powerful new piece of advertising real estate in today's market. It is also potentially the most profitable ancillary distribution channel both for first run network television series episodes and interactive games. In addition, as claimed in this inventor's prior disclosures, the cellular phone's innate features including keypad and display are tailored-made to manage the order and sale of audio and video programming as well as live event content Recordings (when made available) throughout the world.

To sports scores, stock quotes, news headlines and promos for products and television series episodes, we now add ring tones, ringback tones, songs, music videos, and sports action stills to the content being offered mobile phone subscribers.

So far, however, it is the mobile carriers and not the producers, talent and copyright holders that are making most of the profits from wireless exploitation. While news, sports scores and stock quotes are usually packaged at a fixed price per month, cellular carriers assess a high surcharge for ring tones and full-length content. For example, a song that can be downloaded from an Internet Website for $.99 has an average 225% mark-up to $2.25 when the consumer orders the same download to his mobile phone.

In the ancillary market of PC Webcasts where studios and producers offer consumers television, radio and podcast first run release programming for coincident or delayed viewing and/or listening on their personal computers, consumers are either charged pay per view or a subscription fee (usually on a per month basis). In those instances when the consumer is offered a “no charge” option, however, the consumer is frequently forced to watch a Webcast commercial (or a simulcast window commercial) on his PC, the same as he would on free television. The technology that allows consumers to fast-forward through commercials on television sets is not yet available for Webcasts over wired and wireless networks. Statistics nonetheless demonstrate that consumers are willing to watch Webcast commercials on their PCs if they don't have to pay for the program content.

The same is not true, however, for program transmissions to cell phones, PDA's, Blackberrys, Palms, Treos and the new line of phone or combination phone-media players that consumers carry with them all the time. Smaller video screens and the consumer's short attention span when on the run make viewing of commercials particularly offensive and the consumers don't watch them.

Program sponsors, therefore, need alternative solutions for the wireless market to ensure that either commercials are watched or their brands promoted by alternative means in exchange for program investments.

### IV. LIVE CONTENT

Contrary to filmed television productions (series, dramas and sitcoms), advertising revenues for live television programming including professional sports, music specials and talent competitions are skyrocketing. These broadcasts are often of events attended by live audiences.

License fees for live event broadcast rights are now at a premium in the fields of professional sports and the newer talent competitions. For the two-week air rights for the Olympics, for example, commercial networks vie years in advance with the fees then laid off on sponsors and global brands. This business model still works because Nielsen ratings confirm that television viewers still prefer to watch professional sports live as they air. In fact, it works so well that advertisers produce their most expensive commercials for the Olympics and annual events like the Superbowl.

The same reasoning and statistics have been shown to apply to the newer talent competitions and reality shows. In the past year and for the first time in history, the press reported that advertising revenues for the final two episodes of “American Idol” actually surpassed those for the Superbowl.

### V. THIS INVENTOR'S PRIOR PATENT APPLICATIONS

As claimed by this inventor in her prior disclosures, an efficient if not the most efficient means to maximize the exploitation potential of live content, enable interactive capability and manage the sale and administration of event-related Recordings is through implementation of electronic ticketing and entry pass operations integrating information from those pre-authorized to attend with those not pre-authorized that comprise the rest of the world. Revenue potential is further maximized by means that expedite editing and packaging of live event content Recordings in all formats and over all available networks to take full advantage of audience impulse buys and ads issued, ordered and placed over the Internet that reach a global audience.

### VI. THE INSTANT CONTICUATION IN PART

Additional means and apparatuses are claimed in the instant Continuation In Part to provide a complete end-to-end, one-stop solution for global brands when they sponsor live events and/or mobile-delivered programming emanating from or associated with live events. The means disclosed enable the following:

(i) Simultaneous financing (all at the same time) of live events, their television broadcasts and mobilecasts, if any, and the release of event content Recordings offered for sale or promotional purposes (including the costs of advertising):

(ii) Interactive capability in event-related offerings both by ticket/entry pass holders on the one hand and outside interested global participants on the other, from their PCs, landlines or mobile phone devices, etc.;

(iii) Continuing and extended sponsor exposure by the branding at least one of printed or electronic tickets and distributed event Recordings;

(iv) Integration of systems that account for cash participations and alternative consideration to sponsors (that may include the compilation and dissemination of authorized demographic information on a “per user” basis) while at the same time paying royalties to copyright holders, contractual and statutory participants;

(v) Integration of systems that bill a consumer's mobile phone carrier for either or both of electronic ticketing and Recording purchases;

(vi) Integration of systems that compile statistics on audience and off site interaction with a live event (especially valuable for new talent competitions);

(vii) Authenticated retrieval of sponsor branded event Recordings over wired and wireless networks from location-based, and if desired, also monitored and branded, enabled terminals on and off site from where the event takes place (at an airport, for example);

(viii) Secured and authenticated transmission of event content and Recordings integrating at least one of standard encryption, watermarking and digital rights management (herein “DRM”) to deter unauthorized retransmissions and uploads over the Internet;

(ix) Use of a ticket holder or Recording purchaser's authorized information including prior purchase of a ring tone, music download from a subscription site, or election of a prior electronic ticket display option, for example, as means to promote future events and Recordings (including other products and services of event sponsors);

(x) Expedited packaging, delivery/transmission of mobile first run programming Recordings, interactive games and virtual derivative works based in whole or in part on a staged live event;

(xi) Production and release of increasing varieties of derivative works including interactive games as more e-friends, e-dates and acquaintances seek novel ways to socialize together on-line and exchange information, blogs, preference data and content critiques; and

(xii) Enhanced security and scanning methods for venues, common carriers including airlines and content itself using the same user information as may optionally be integrated with turnstile methods systems including those previously claimed by this inventor.

### VII. UTILITY

The utility of the instant Continuation in Part is demonstrated by the following:

(1) Baseball and football leagues will have means to quickly fulfill orders for memorabilia embossing action plays from games actually attended and not just generic merchandise of the players;

(2) Grand slam tennis tournaments (that already post elaborate Websites tracking the best points) could add to their profits by offering event-related stills to those who log in to access points on their PCs and mobile devices;

(3) Shows like “American Idol” or “Dancing With The Stars” would not need to require viewers to tune in on a second night to get the results of consumer voting and a winner's autographed CDs, DVDs and posters could be offered for immediate sale;

(4) With increasing bandwidth, producers of interactive games [predicted to be the next big money maker in multiplatform entertainment] will be able [as permitted by law] to stage new types of virtual tournaments (for example, by daring spectators both on and off site to guess the trajectory of a ball or path of a race horse). Such contests could be staged in close proximity and time with the event itself with interactive capability enabled from the number/keypads of cellular phones, PCs, landlines and enabled television sets;

(5) In the medical and educational conferencing fields (huge markets for packaged mobile-delivered content), drug manufacturers, universities and medical centers will have means to deliver symposium highlights immediately to the devices that attendees carry with them all the time. Physicians have demonstrated a marked preference for capsulated FDA releases in lieu of the voluminous new drug literature disseminated on discs, CD-ROMs and Websites. Once a physician has attended a conference or learns of a great new drug or therapy, he wants the adverse biochemical reactions and dosages right on his phone, Blackberry or Treo. Registration information and electronic ticketed receipts (regardless of whether the attendee has actually paid for his right of entry or has been given a promotional pass) can be used not only to authenticate distribution and retrieval of capsule Recordings but also to enable conference interaction both at the live hosting venue and from networked devices;

(6) Use of authorized data to manage order and fulfillment of full-length event content (concerts and TV series episodes), or spliced and edited Recordings (individual songs, “best of tour highlights”, narration tracks and song performance videos logged to time codes);

(7) Maximization of event content revenue to all of event producers, broadcasters and sponsors to take full advantage of audience impulse buys and ads issued, ordered and placed over the Internet that reach a global audience;

(8) Effective and extended sponsor exposure by logo or icon branding of electronic tickets and released event Recordings; and

(9) Heightened security both for the hosting venues and event copyright holders.

### VIII. ADVANTAGES OVER PRIOR ART

The instant disclosure claims and reveals that by issuing electronic tickets and/or releasing event Recordings branded with the sponsors'ad, icon, message, logo, etc., and integrating the inventor's prior methods and disclosures, the following problems inherent in financing live productions and distribution over all networks and in all media are virtually eradicated, including:

1. Elimination of multiple levels of production dollars needed for event production and broadcasts on the one hand, and event Recordings on the other, including advertising;

2. The public's increasing desire for more and more mobile content and offerings including with interactive capability;

3. The need for an effective advertising solution for program/content sponsors particularly now for cellular phone market independent of buying ad space on search engine Websites and their links;

4. In the music industry, expedited means to finance, edit and package live performances and event-related merchandise that traditionally were not made available in spite of a huge buying market. For example, the Metropolitan Opera Store and most classical venue retail outlets still only sell prerecorded studio CDs of featured artists and not the performances attended. In addition, for new bands and unsigned talent, better means are needed for global promotion and marketing including onsite distribution at actual performances. And for veteran artists and their labels, a solution has not yet been implemented for making available ongoing live performances even when they are attended by low volume audiences that will help reverse the last ten years of album revenue losses emanating from digital piracy of song titles over the Internet;

5. In professional sports, expedited means to package and offer game-determined content, celebrity-endorsed videogames, tournaments and memorabilia embossing plays from the actual event attended;

6. Better and expedited means to release highlights of professional and press conferences to promote hard news, new drug information, and other products and services (including on site to the mobile devices of attendees and invitees while the event is still fresh in their minds);

7. Better means to market universities, professors, lectures and educational seminars;

8. For live event creators, copyrights holders, statutory/contractual participants and global sponsors, better means to maximize and account for revenues from audience impulse buys from their live event and ads issued, ordered and placed over the Internet that reach a global audience;

9. For live event creators, the ability to offer interactive capability both to attending spectators and non-attending but interested consumers around the world from their personal terminals and devices;

10. For event producers and promoters, the ability to expand “attendance” and interactive capability to persons other than the physical audience;

11. Means to advertise future events and Recordings by using both the ticket holders and Recording purchasers'past, present and future present digitized data (for example, prior order of a ring tone, music download or election of electronic ticketing);

12. Means to finance and update authenticated Recording retrieval systems accommodating multiple formats on and off site from where an event is hosted including due to ongoing advents in technology;

13. Alternative and effective means to compensate sponsors for program investments;

14. Use of cellular phone technology and circuitry including electronic identification numbers (“EINs”), display screens, etc. to simultaneously enable heightened security measures at event venues and transportation [air line] terminals and to secure event content; and

15. For the transportation and airlines industries, means to enable and account for consumer participation in ongoing entertainment, sports and gaming offerings around the world (including, for example, those being staged in a city on the actual day of travel) to include authenticated order and retrieval of Recordings on cellular devices.

### IX. PRIOR APPLICATIONS OF THIS INVENTOR

Prior applications of this inventor claimed means that use at least one of a cellular phone, PDA, Blackberry, Treo, IPTV, other electronic mobile device, a device's electronic identification number (“EIN”), electronic display, bar code, the user's DNA fingerprint and other uniquely identifying information as an electronic ticket or entry pass such that at least one of: (i) pre-authorized entry to an event, venue or transportation terminal; (ii) added venue and content security measures; and (iii) event interaction is enabled from mobile devices. The claimed interactive functions were defined to mean input/processing of consumer responses related to or associated with a live event including, by way of example, questions, answers, ratings, voting, blogs and comments and order of event-related Recordings. Such means were disclosed to enable, by way of example, new forms of social gaming and tournament play, to pick the winner among featured talent or products, to select of one of several possible endings to a stage play, movie or videogame, etc., and/or to immediately buy content related to the event.

Specifically disclosed were means to use a mobile phone, PDA, Blackberry, Treo, hand held media player, IPTV, a device's electronic identification number (“EIN”), call number; display, registration pass, receipted data, Web subscription or institution account number; bar code, credit card, smart card, encryption codes, fingerprint scans, DNA scans, iris scans, and/or other uniquely identifying data of a consumer (previous purchase of a ringtone, or song download from a Website, etc. or election of electronic ticket) to authorize entry to a venue and enable both or one of venue and event content security.

This inventor's prior applications also claimed:

(i) the enablement of wireless devices and in particular those that are phones with the above stated functionalities including use of number/key pads for interaction;

(ii) novel methods and apparatuses to manage the live music, entertainment, telecom, television, conferencing, education and airline industries including new theatre, set, turnstile, hospitality table, chair/seat and kiosk designs and administration of ordered event Recordings;

(iii) enabled turnstiles, scans, audience chairs, seats, hospitality tables, kiosks and other apparatuses including those that: (a) authorize a consumer's entry to a venue or event including air line terminal by dialing the phone number assigned to a turnstile, as may be branded, from his cellular phone or other enabled portable device; (b) use EIN numbers assigned to cellular phone devices to authorize entry to a venue, transportation terminal and/or activate release of a Recording; and (c) read or process information from cellular devices, electronic tickets, credit cards, etc., to buy food and beverages without a waitress, pay checks and parking, etc.; and

(iv) methods of digital editing, packaging and accounting to enable expedited release and administration of event-related Recordings, products and services over wired and wireless networks including on site at a venue or transportation terminal before and during an event, performance (or flight) or by the time it ends.

The inventor claimed that by buying a “ticket” or having an entry pass issued and receipted by any means including using a cellular phone device or its EIN, those attending or participating already outlined a potential market for sale of the event's Recordings.

The inventor also claimed that transformation of content into “bits” whether audio, video, a concert, music, photograph, lecture, conference, play, sports stills, videogame, etc., would merge with the same bits identifying global consumer purchasers and their input commands.

The inventor further claimed that a cellular phone's electronic identification number could itself be the electronic ticketing authorizing ingress, enhancing venue security and enabling order and retrieval of an event Recording (for example, by having the attendee dial (a) number(s) assigned to the turnstile at the time of sought entry and egress to effect transmission (See, FIG. 9, infra).

The inventor also claimed that a phone or PC keypad could serve as the facilitator for input of authorized and authenticated command responses both from those in physical attendance and those geographically isolated (for example, watching live at home live on television set, PC or mobile phone device).

The inventor's divulged means and apparatuses included methods and apparatuses for digital editing and packaging, thereby enabling immediate transmission of live content over wireless networks, and if desired, to cell phone devices and location-based on-site terminals.

The inventor further claimed apparatuses and designs in the form of enabled turnstiles, audience seats, chairs, tables, theatre set designs and kiosks enabled to retrieve event Recordings or venue-associated products and services during a concert, flight, hotel stay, shopping mall spree, ATM transaction, showcase, recital, musical, play, ballgame, or staged competition.

The inventor claimed as part of a complete method for management of Recordings means to account for and pay all contractual and statutory royalties from every user's point of sale.

For mobile content transmissions, the inventor also claimed means to enable direct billing by the mobile carrier including [and/or integration of billing systems compatible with those of telecom mobile carriers] to charge both electronic tickets and purchase of event Recordings.

### X. PRESENT DISCLOSURE AS A CONTINUATION IN PART

The present disclosure is a Continuation In Part to this inventor's prior filings. It anticipates the public's increasing desire for new forms of content and interactive offerings and the potential financing of the whole or parts of such offerings especially those distributed over the Internet and to mobile devices by global brands. It claims the placement of a sponsor's trademark, logo, icon, advertisement, message, public service announcement or other branding upon a ticket, as herein defined, and event “Recordings” associated with or emanating from events, venues and modes of travel including airlines.

The present disclosure provides a sorely needed solution for producers, talent, labels, studios, common carriers and their sponsors or ad customers to enable content exploitation over cellular networks by extending brand and endorsement exposure beyond what was possible on television and billboards. In addition, it provides a technological advertiser solution independent of buying ad space on search engine Websites and their links.

The instant disclosure offers the following benefits over current systems:
(1) Enables the simultaneous branding of live events, broadcasts, if any, and event-associated Recordings;
(2) Enables authorized user entry, interactive participation, fulfillment of Recording orders and heightened security methods just by using a cellular phone device;
(3) Enables participation and interactivity by audience spectators and those physically and geographically isolated to expand the promotional value for event sponsors;
(4) Enables direct billing for all functions, offerings and orders by mobile carriers;
(5) For international concerts, tours, sports competitions and product conferences, allows for enhanced and effective sponsor marketing by enabling entry pass and ticketing data to be used to redeem tie-in merchandise and bonus discounts on tie-in merchandise;
(6) Enables prospective event Recording buyers the option of delaying a decision on purchase until after the event has started or is over;
(7) Offers artists, celebrities and producers means to finance and immediately package and manage distribution of event Recordings throughout the world and at cost low enough to make distribution desirable even for low volume live audiences;
(8) Offers the adoring public access to a more comprehensive repertoire including of even smaller local events;
(9) Ensures that more and more live content will be made available to be enjoyed beyond the attending audience;
(10) Paves the way for new entertainment and gaming offerings;
(11) Provides a solution to reverse revenues over the last ten years attributable to unauthorized digital piracy of content over the Internet; and
(12) Presents an advertising solution independent of buying space on search engine Websites and their links.

### XI. BRIEF DESCRIPTION OF THE DRAWINGS

FIG. 1 depicts a schematic or block diagram for a sample recording and distribution system.

FIG. 2 depicts the schematic of a data center implementation.

FIG. 3 depicts the transaction flow including processing and administration of Recording orders, orders for interactive participation, and payments and accountings to all copyright holders and participants (or “partners”) with optional billing by mobile carriers.

FIG. 4 shows a flow chart for processing transactions including entry transactions and information requests.

FIG. 5 depicts the method and system of manufacturing/fulfillment including orders for complete, edited or special purchase Recordings including those to be branded by sponsors.

FIG. 6 depicts the methods and systems of on and off-site Recording production, fulfillment, distribution and authenticated retrieval.

FIG. 7(A)-(P) depict the inventor's apparatuses and designs both alone and in action within the network.

FIGS. 8(A)-(B) depicts sample mobile apparatuses enabled for electronic ticketing and sponsor branding.

FIG. 9 depicts a sample turnstile security method.

### XII. DETAILED DESCRIPTION OF THE PREFERRED EMBODIMENT

While the instant invention is susceptible of embodiment in many different forms, there is shown in the FIGURE DRAWINGS and herein described in detail preferred embodiments of the invention with the understanding that the present disclosure is to be considered an exemplification of the principles of the invention and is not intended to limit the principles or scope of the invention to the embodiment.

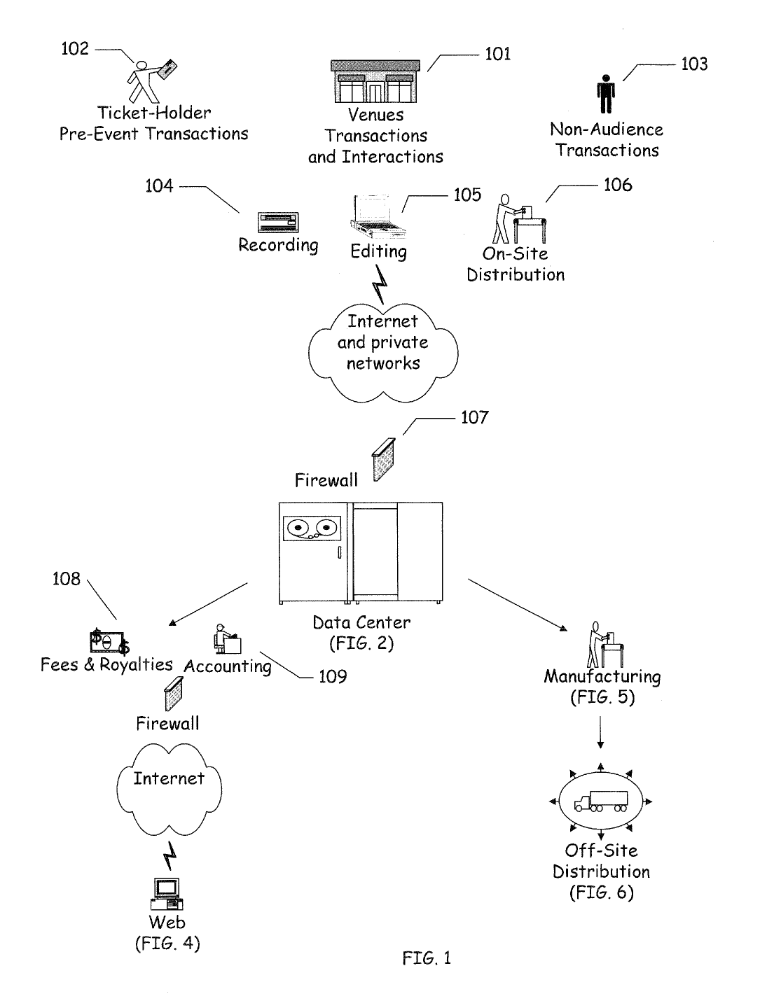

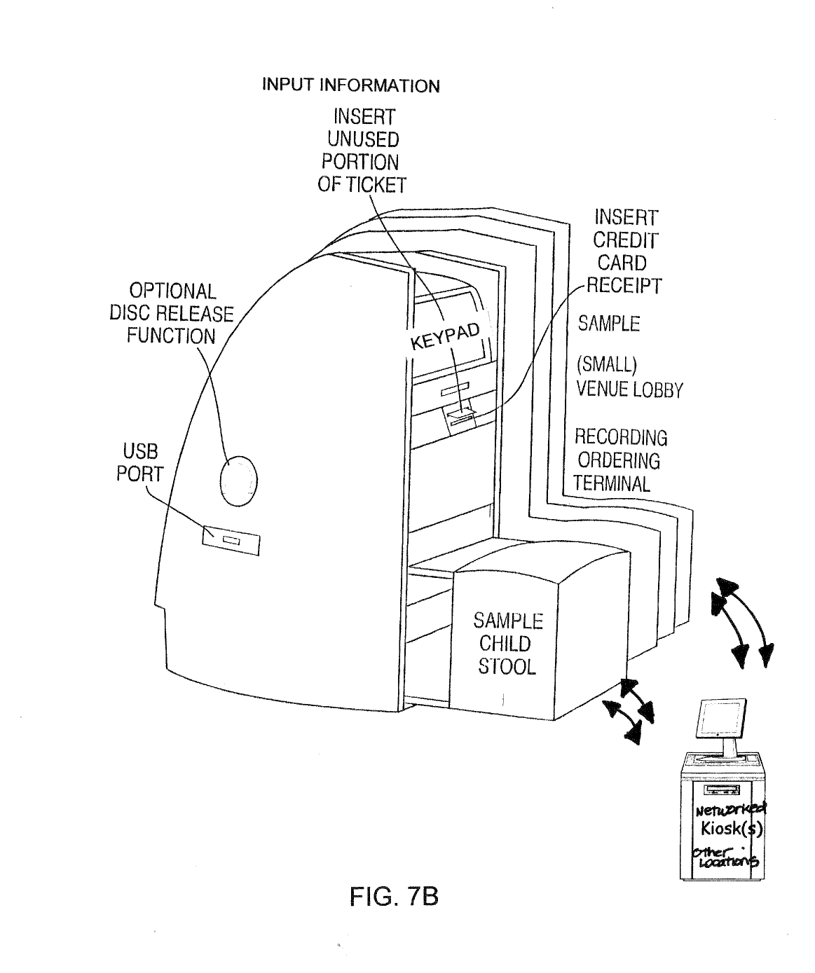

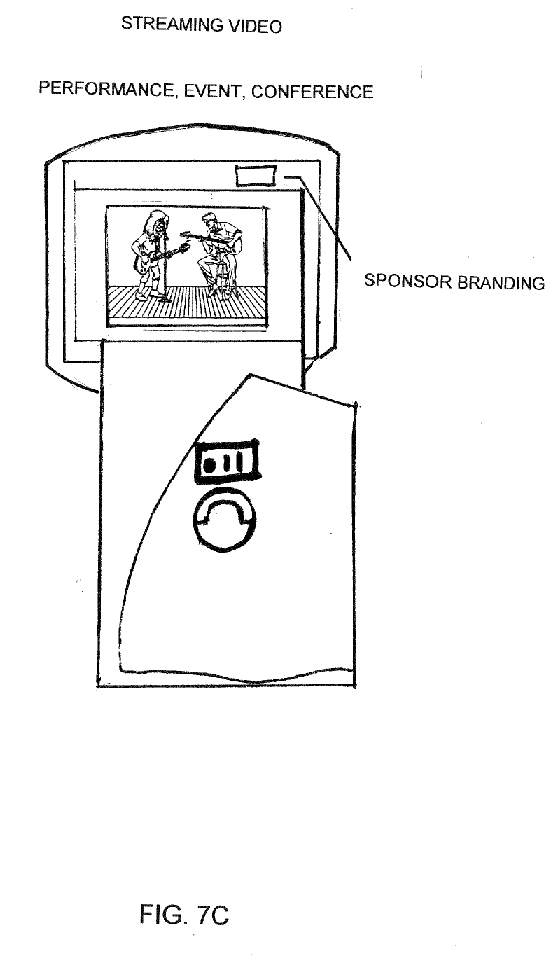

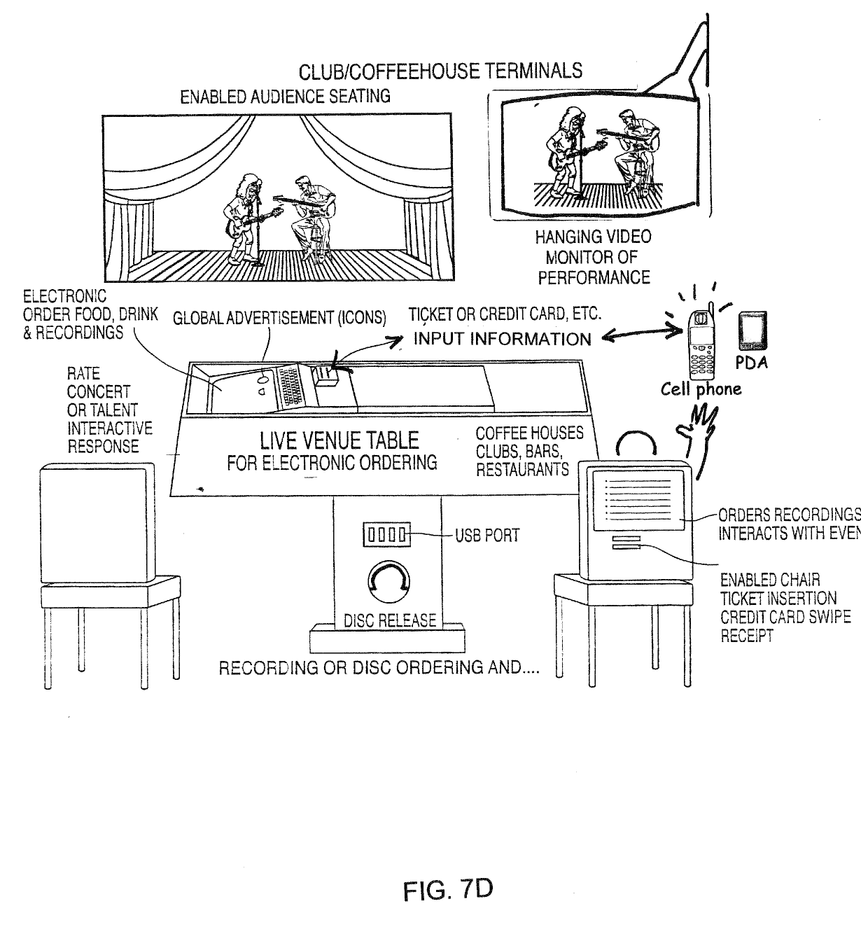

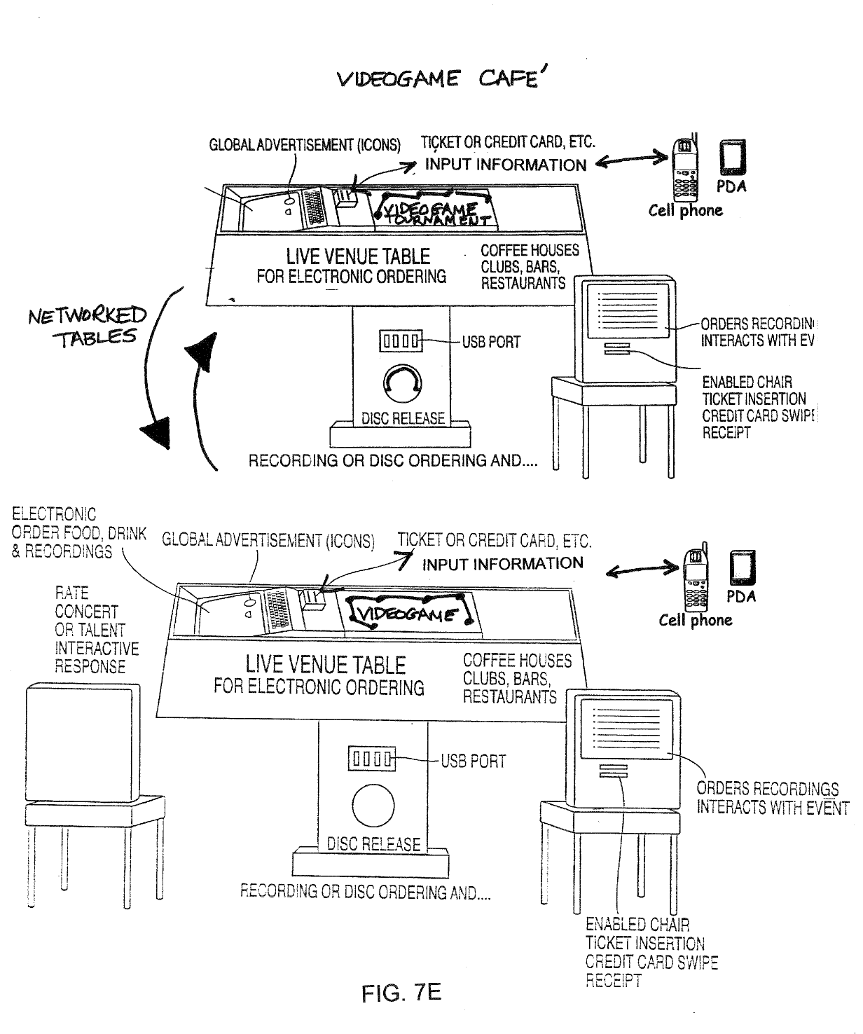

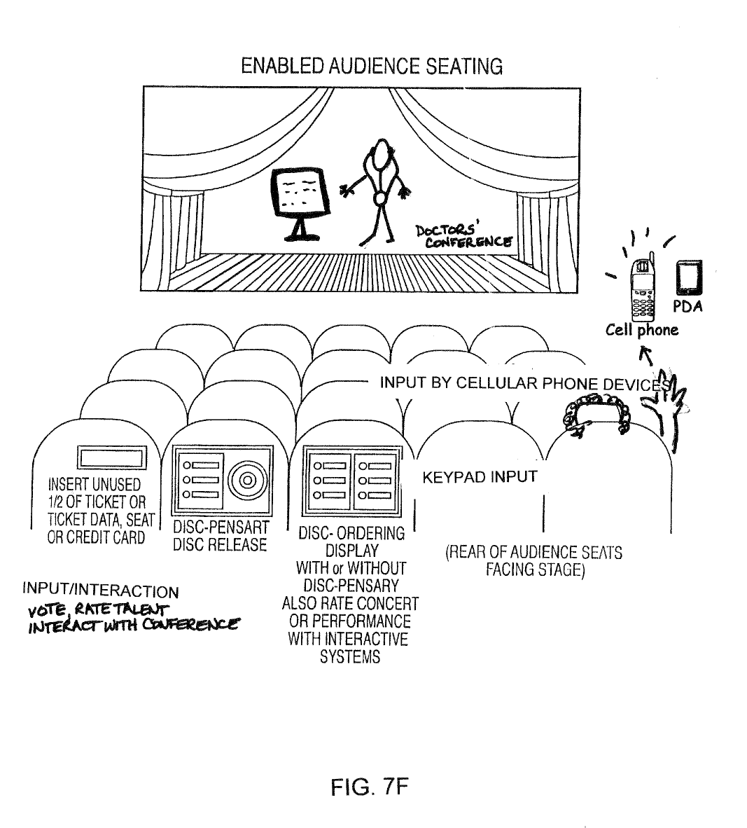

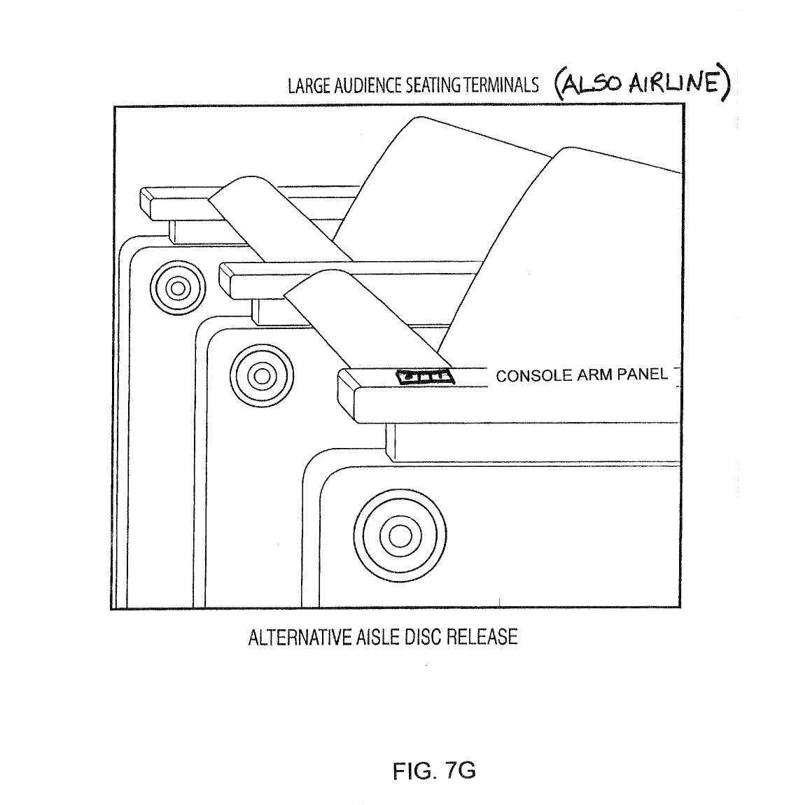

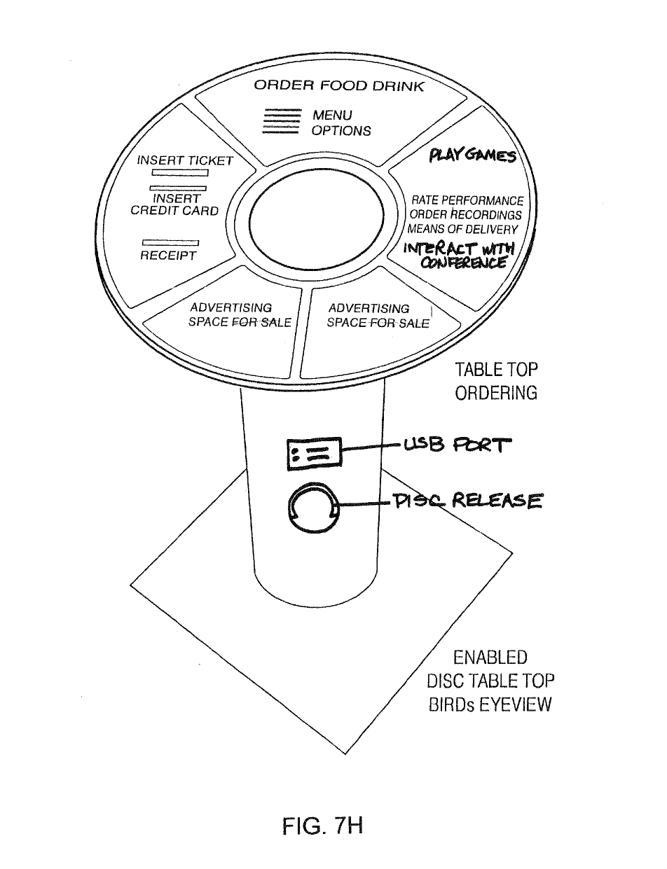

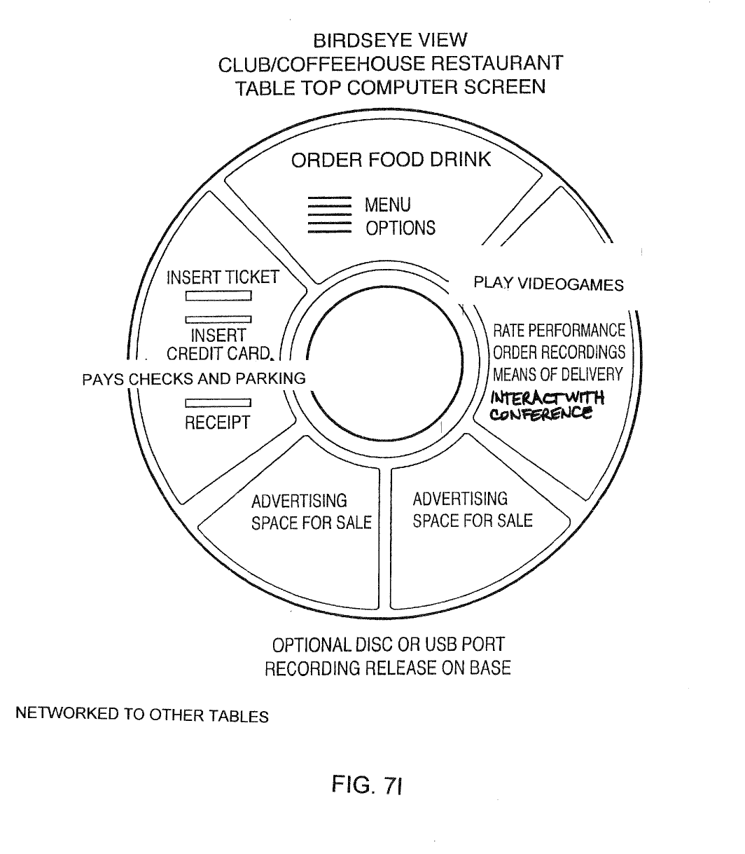

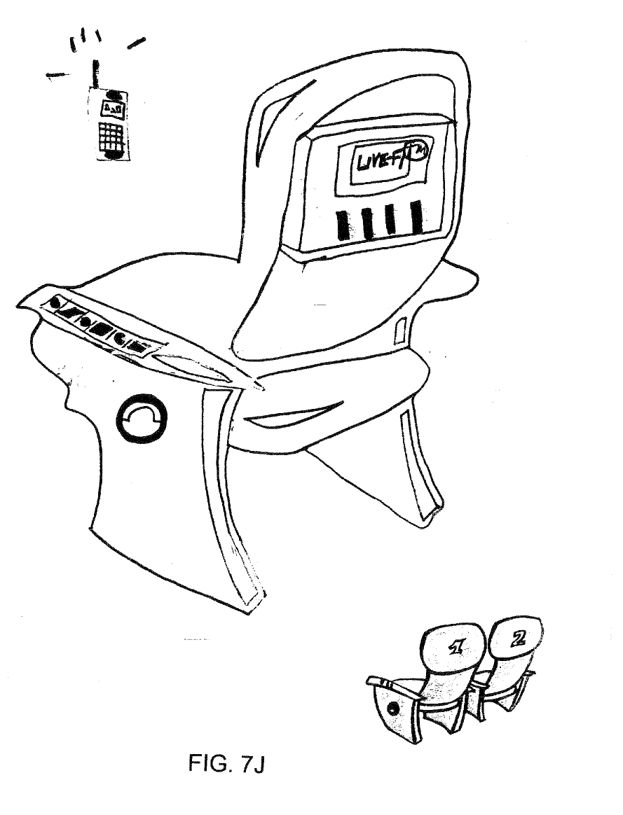

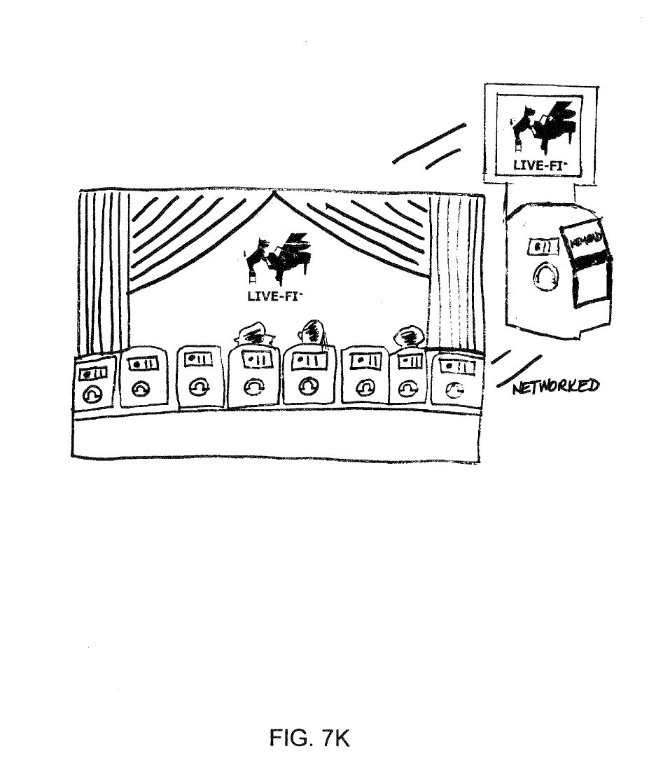

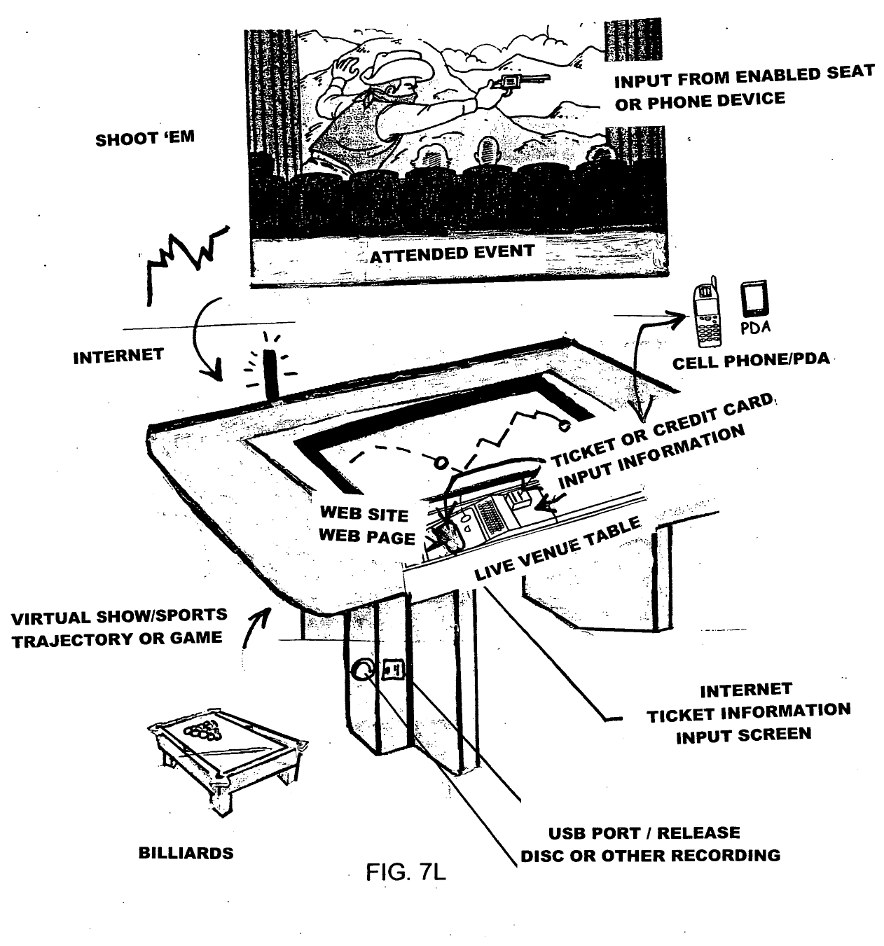

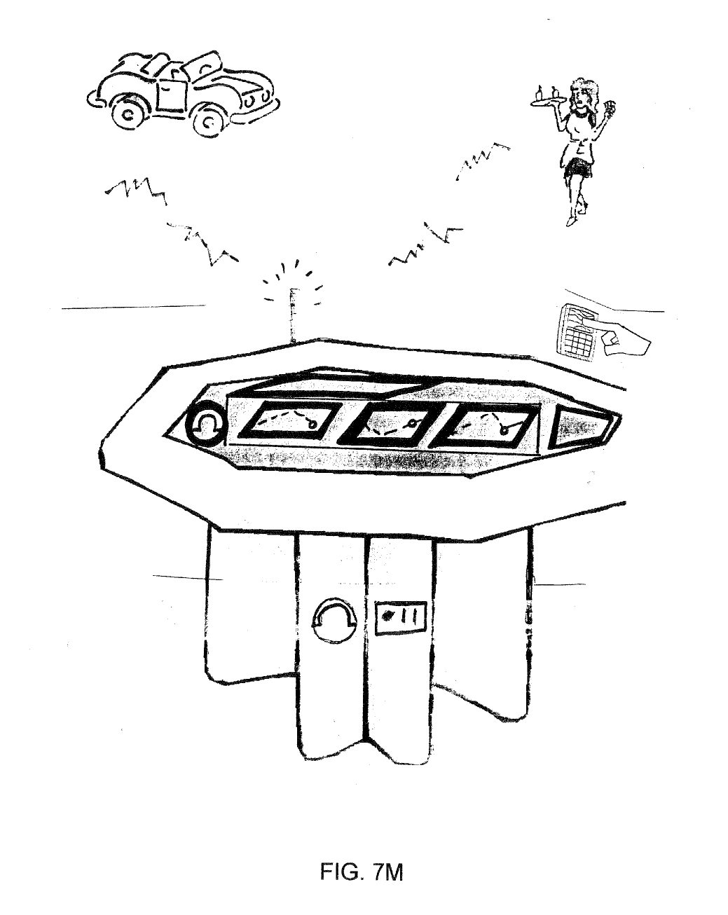

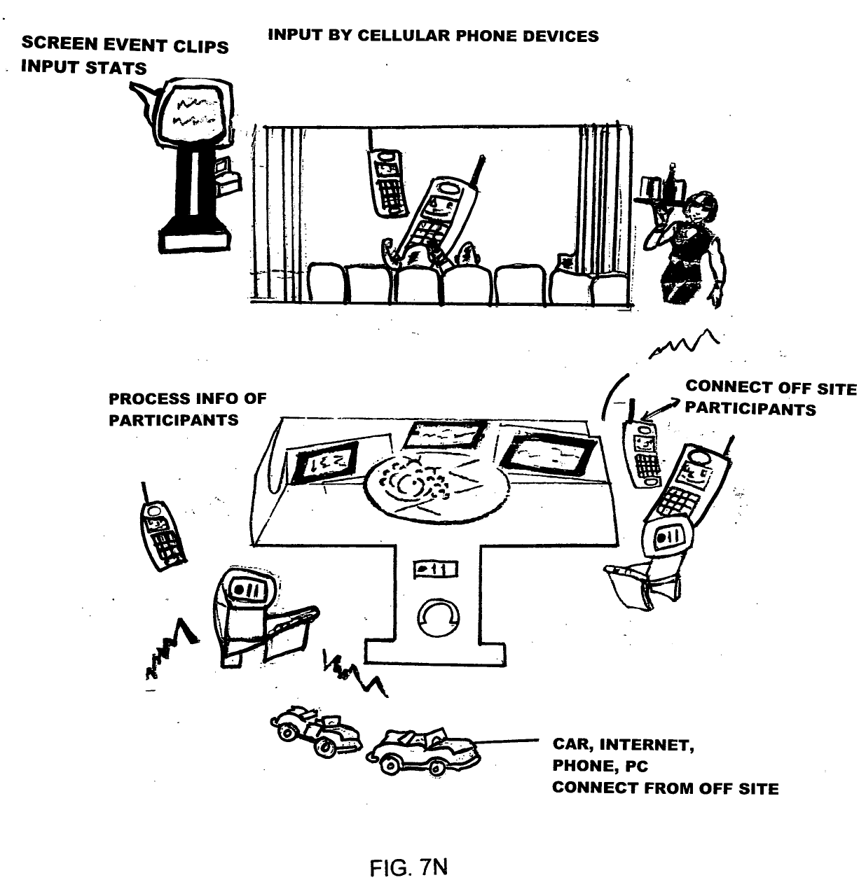

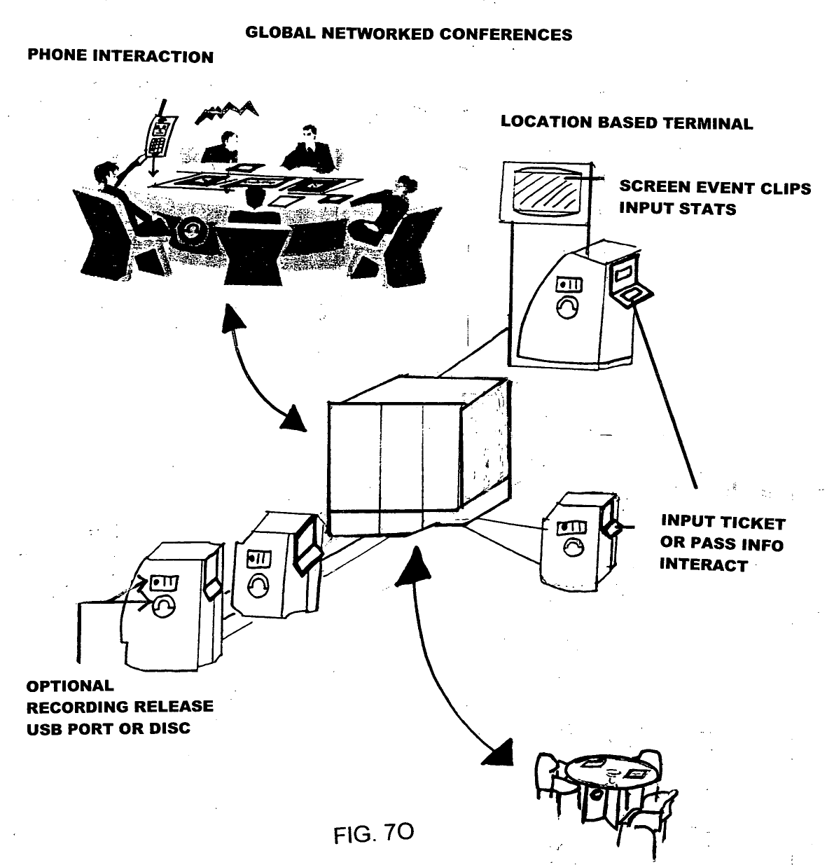

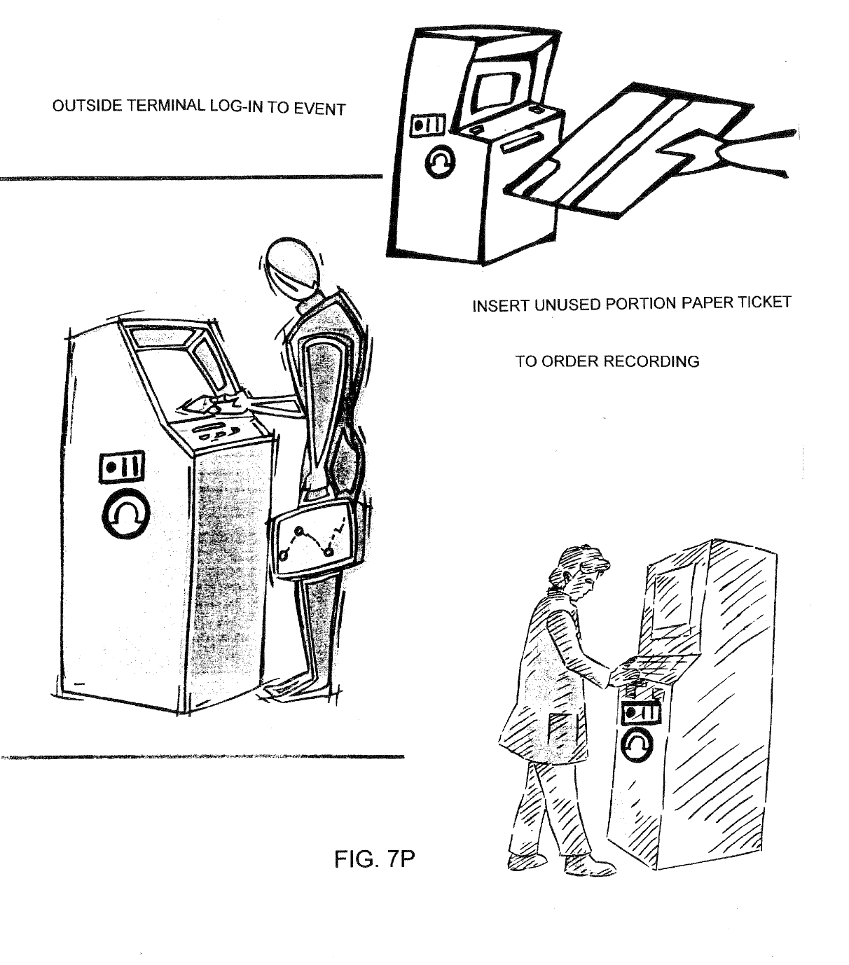

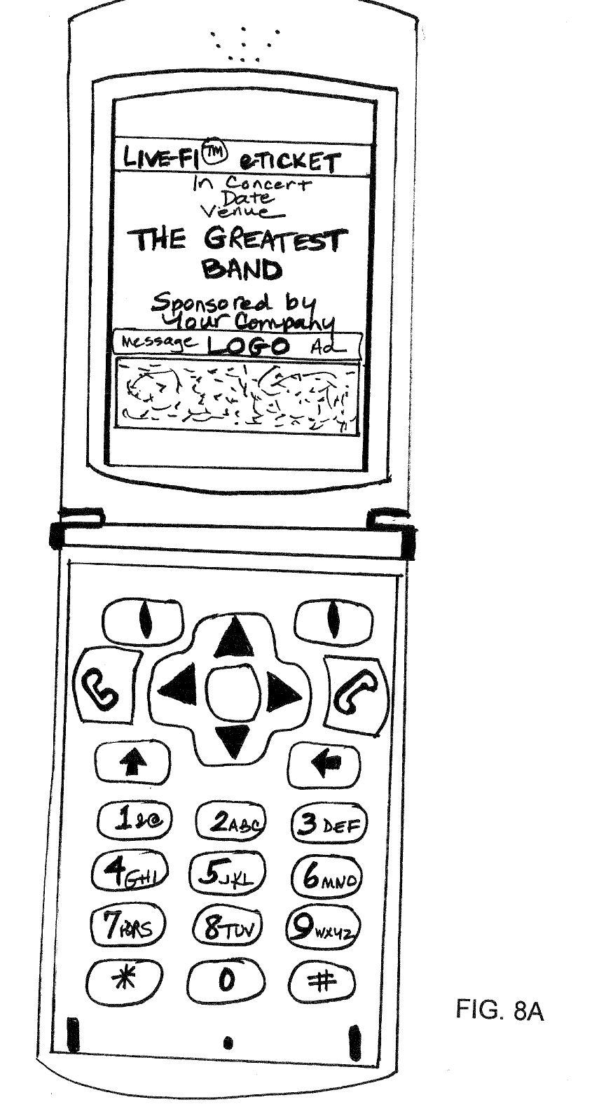

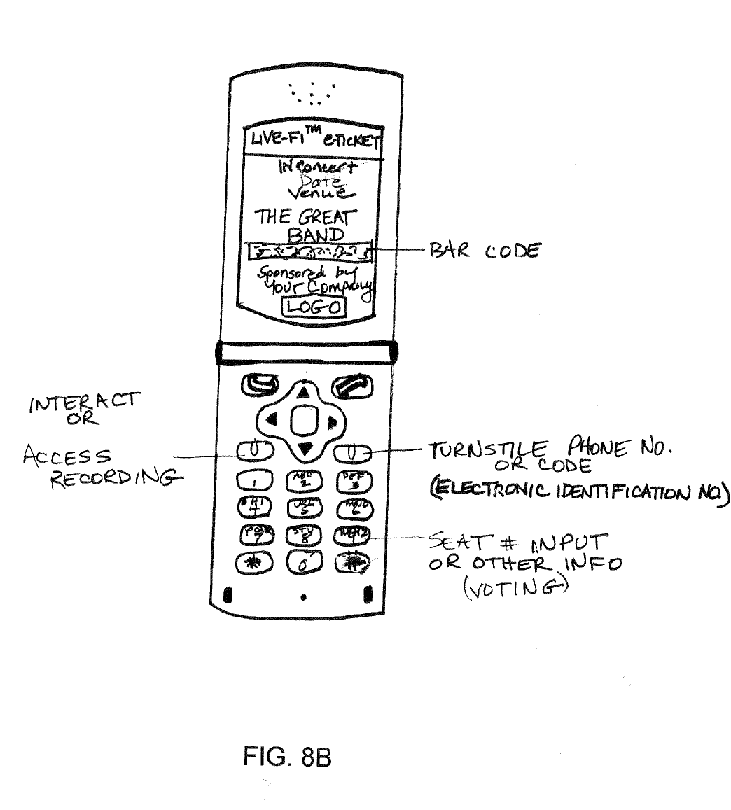

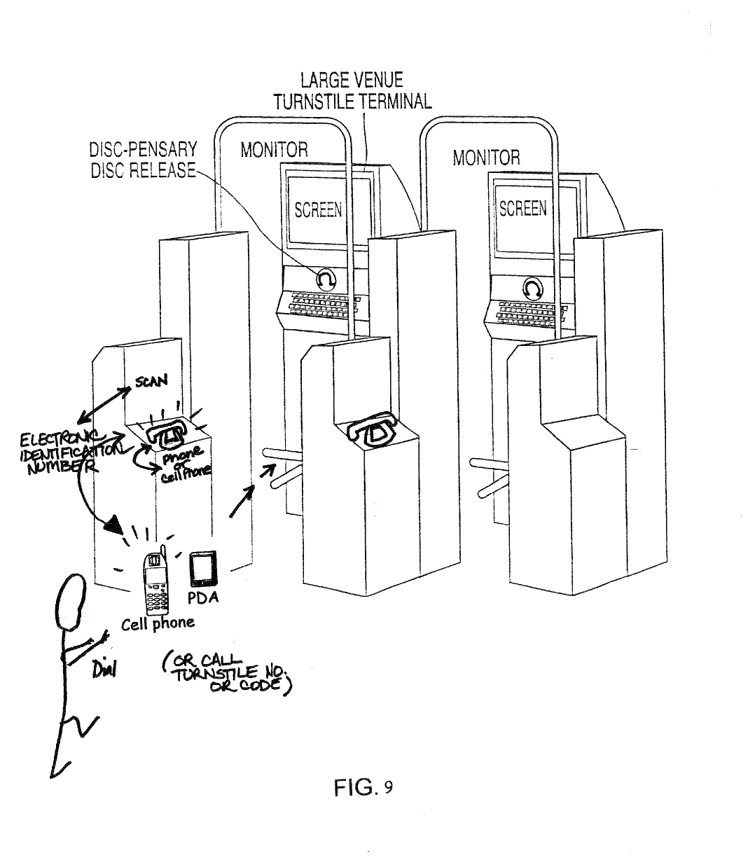

In referring to FIG. 1, a schematic or block diagram for a sample recording and distribution system is implemented using a Data Center, a plurality of venues including concert venues, sports stadiums, theme parks, movie theatres, Broadway theatres, OTB locations, common carriers/air lines etc., using standard point of sale equipment and a plurality of terminals that include without limitation, location based enabled kiosks [examples of which are shown in FIGS. 7(A)-(P), FIG. 9], PCs, and personal terminals of users including PC's and wireless mobile phone devices of audience spectators and off site participants/Recording purchasers (FIGS. 8(A)-(B)).

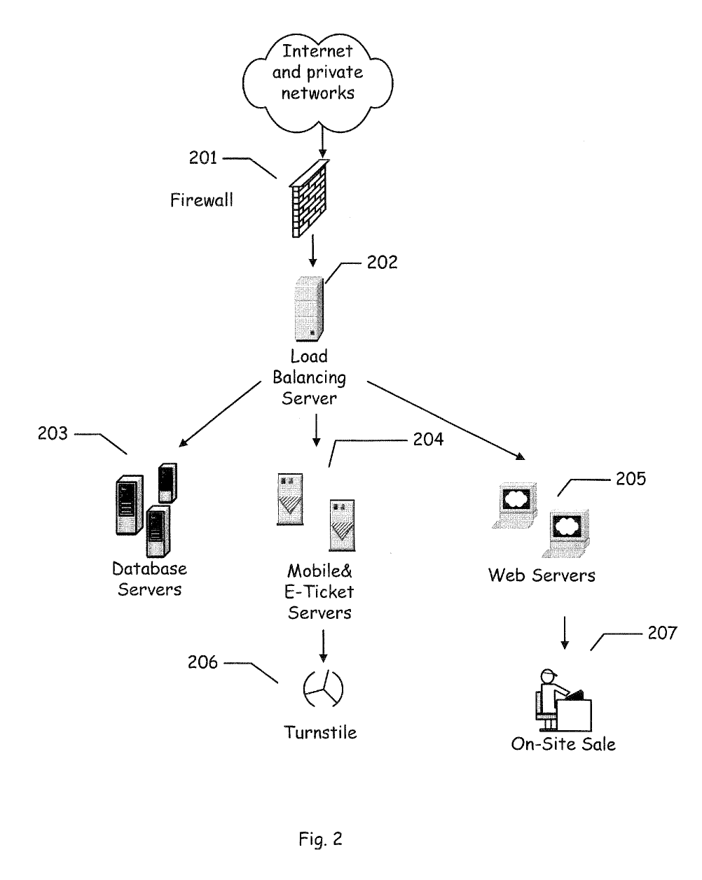

The Data Center (FIG. 2) is in communication with each venue and each purchaser, subdistributor, or licensee's terminal through the Internet or any wireless application. The terminal can be any device through which a user can access a Website, e.g., a personal computer, a personal digital assistant, an Internet-through-television device, a cellular telephone, IPTV device, PDA, Blackberry, Palm, Treo, or any other type of many available wireless devices available in the market or any updates as may now or hereafter be devised.

Referring to FIG. 2, the Data Center preferably comprises database servers (203), Web servers (205), and mobile servers (204), a load balancing router (202) and a firewall (201) connected to the Internet. The firewall (201) receives messages from the Internet and forwards the messages to the load balancing router (202) and likewise receives messages from the load balancing router (202) and forwards them to the Internet or other similar distributed computer network. The firewall (201) preferably performs a number of filtering functions and network address translations in order to safeguard the Data Center from unauthorized access. The firewall (201) also preferably encrypts the message using known public key/private key encryption or DRM methods as may now exist or hereafter be devised. The load balancing router (202) forwards messages received from the firewall (201) to one of the plurality of Web servers (203, 204, 205). The load balancing router (202) also forwards messages received from the Web servers to the firewall (201) for transmission to other sites through the Internet. In this manner, the load balancing router (202) distributes tasks to be performed to one of the plurality of servers (203, 204, 205) in order to distribute processing demands. The servers access the database servers to retrieve and store information in response to received messages from the terminals (not shown). The database servers store data tables which contain information about various venues, events, accounting, direct charging by mobile carriers, when applicable, royalties payable, fixed payment allocations, ticket resources, user rules, ticket status, entry/registration passes, placed bets, type of entry authorization (paid, free or promotional), mode of receipt, ticket and entry pass holder information, tournament entrance fees, event interactive options, and other information related to consumers and purchasers including, for example, prior ticket orders (including electronic tickets), downloads of songs, ringtones, or other merchandise purchased from a Website.

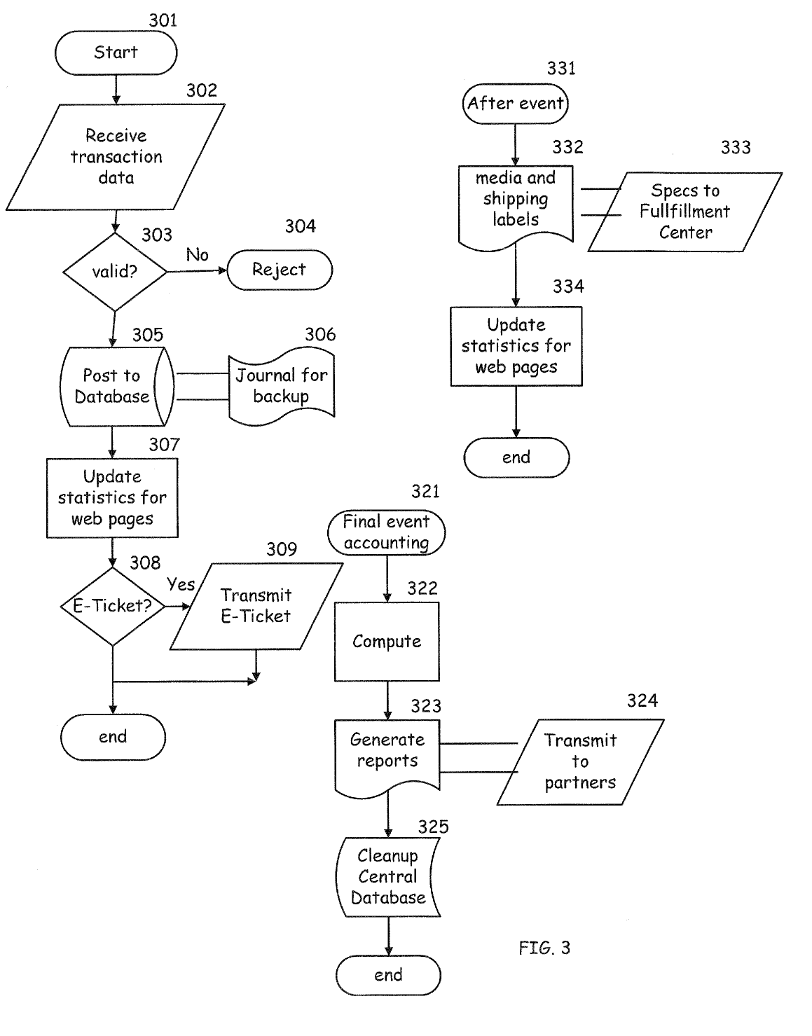

An end user can access the Data Center (see also FIG. 3) by using a standard Web browser on a terminal (205) or on his cell phone (204). However, non-standard, custom software can also be implemented or Web browser software on a wireless device such as a PDA, Blackberry, Palm, Treo, or IPTV. Terminals can log into the Data Center to view events which will take place in the future, whether promotional discounts are available on tickets or Recordings, purchase tickets, request registration passes (in the case of a physicians'professional drug conferences), allow patrons to access Recordings from a just-completed live event, interact with the event (like rate a featured new act, song or artist), buy interactive games and/or participate in staged tournaments with other users or spectators (102).

Moreover, other information including user roles, options for Recording retrieval including location, format (CD, DVD or USB), means of retrieval and incorporating burning, engraving, balancing, editing, or splicing technology as may now exist or hereafter be devised, may be implemented. Choices may include venue, management, artist, record label, team owner, sports league association, OTB operation, event/conference sponsor, drug manufacturer, event management, ticket buyer/ancillary purchaser, event interaction, mode and location of retrieval (for example, immediately at venue by CD or DVD, delivery by digital transmission/USB port at a location based kiosk, at home by regular mail or by home computer access, on a cellular telephone, PDA, Blackberry, Treo IPTV device, etc.), elections to input other demographic information for dissemination, special orders and derivative works (singles, edited versions, director's cut, narration tracks, conference highlights, product information, etc.), and request upload of demographic information and promos for upcoming events and other releases, etc.

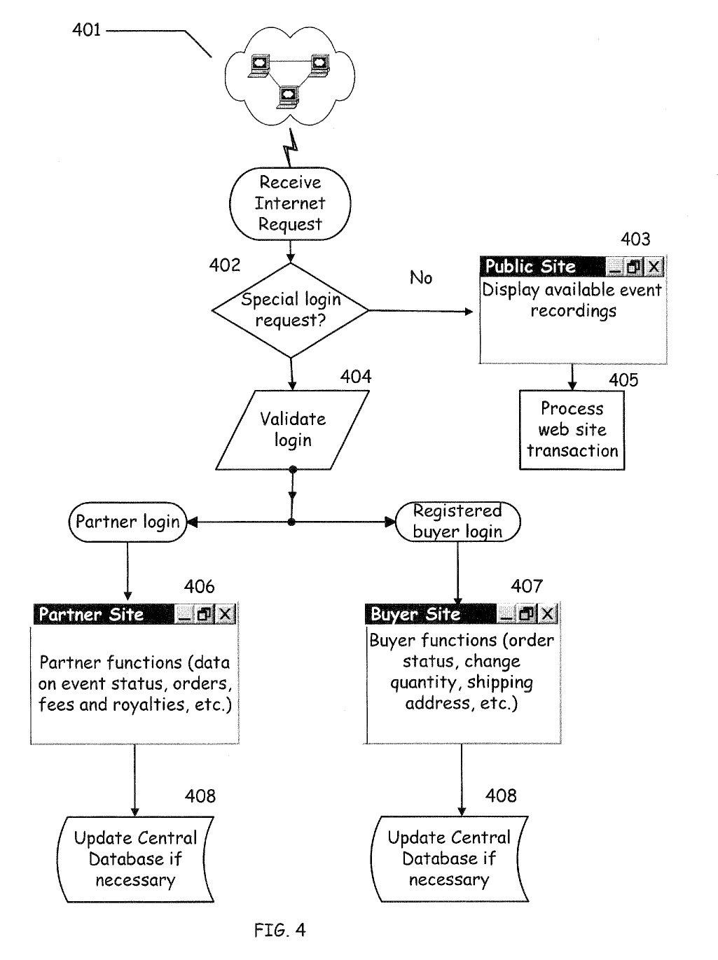

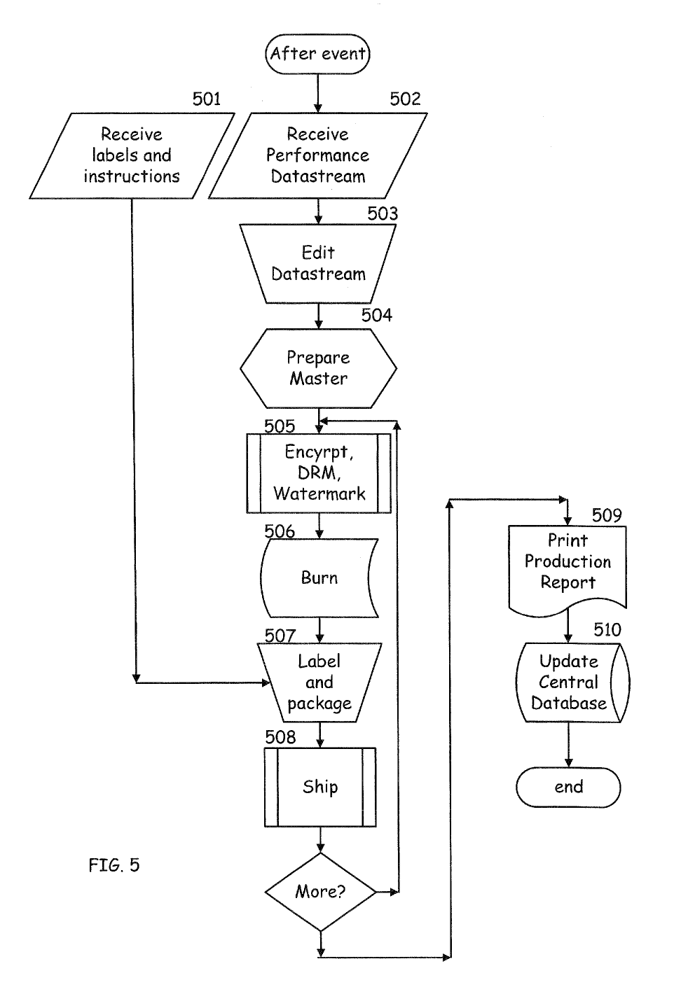

More particularly, referring to FIG. 1, the system further includes one or more venues (entertainment, concert halls, sports stadiums, air lines and common carrier line terminals, OTB locations, etc., new gaming franchises) (101), a fulfillment or manufacturing center (FIG. 5), a plurality of information recipients (108) and a plurality of Recording recipients (FIG. 4) and/or participants (FIG. 4). The transaction flow is depicted in FIGS. 3 and 4.

Regardless of whether the attendee has to pay for entry or is issued a free entry pass, he called a “ticket holder” (102) and the transaction authorizing entry is recorded in step (104). During this step, the ticket holder (102) may be presented with the option of receiving an electronic ticket, interacting with the event, pre-buying a Recording and electing its format and mode of retrieval/delivery including to a cell phone in which event additional information from the ticket holder may be requested and processed (for example, his phone EIN, call number and mobile carrier). When a mobile carrier is involved, such information is transmitted over the Internet to the mobile carriers'servers (204) and the e-ticket is enabled at steps (308, 309) (FIG. 3). In any event, the price of the ticket, interactivity (a service), when a charge is being assessed therefor, and/or a Recording, may be added to the price of his ticket purchase (or other logged entrance fee or bet information), or when applicable, charged by implementing software of the purchaser's mobile phone carrier or by the mobile carrier directly. In addition or in the alternative, an uncharged bonus offer to interact with the event or input a comment or rating may be logged. Of course, if the phone itself or a display thereon is itself to serve as the electronic ticket, the charge of enablement may also be charged by the mobile carrier and appear directly on the user's cellular bill.

In the event the purchaser opts to retrieve a Recording at the venue immediately upon completion of the event or performance (or prior to in the case of virtual tie-in games and tournaments), standard authentication methods may be employed, including, but not limited to, reading of a user's cell phone's EIN, a Website order previously accessed by the consumer, or other information authentication. For EIN authentication, the user may by way of an example, call from his cellular phone device a phone number assigned to the turnstile or location-based kiosk to authorize entry, or retrieval of a Recording or both (FIG. 9). In the event the entry authorizer elects to enable sponsor branding, a sponsor's logo or ad may be electronically displayed in addition to some data comprising an entry authorization receipt (FIG. 5 (501, 507)); FIG. 8(A) and (B)). For such display, any number of security devices and/or methods, such as but not limited to, bar codes, encryption codes, fingerprint, DNA fingerprint and/or iris scans, etc. may be used including information identifying the event.

Enablement of an electronic ticket takes occurs at FIG. 3 (308. 309) with information transmitted over the Internet to mobile servers (204). Sample cellular phone electronic ticket apparatuses are set forth on FIG. 8(A)-(B) and FIG. 9. This same information can be used to add venue security methods and at the same time permit authentication at turnstiles or location based points of sale for the processing of Recording orders or the purchase of other event-related products and services. It can also be used to authorize subsequent release of promotional information for future events and Recordings with any information stored on the servers.

In the instance where the live event is a sponsored professional or press conference (where attendees are authorized entry free as a means to promote a featured product, sponsor or service), the sponsor's branding, ad or message may also displayed on the displays of cellular phone devices (FIG. 8(A) and (B)) such that the sponsor gets maximum exposure on the person every time the user checks the device to get updates on the event or information related to the featured products.

The ticket issuers/entry authorizers have the option of offering, and the ticket holder or attendee may be given the option of receiving an electronic ticket, receipt, or other secure verifiable proof of purchase/transaction like a placed bet which can be used in place of a physical ticket and displayed on his wireless phone or device (FIG. 8(A) and (B). As aforementioned, in addition, the EIN of the device may itself enable the device and can be used as the ticket (308, 309). The electronically encoded ticket can further contain any number of security devices, such as but not limited to bar codes, encryption codes, finger print scans, DNA scans and iris scans to permit further authentication at location based turnstiles or point of sale locations to add methods of venue security and also enable event content transmissions and retrieval (FIG. 9).

In the one instance when the ticket holder has bought a ticket and elects to pre-buy the right of event interaction and/or an event Recording at the same time, the ticket seller or entry authorizer, who is already making various allocations for taxes, fees, etc., from the gross receipts, treats the price of the value added similarly. He subtracts his fee, whether fixed or contingent (his incentive to provide this service), and forwards the remainder to the Recording supplier (Recording-seller). In this case, because this is still a single transaction, with the ticket itself serving as the customer's receipt, the added cost is minimal. If the cellular phone is to serve as a ticket, the entire billing for entry, interaction and any Recording may be designated to the mobile carrier (204) such that all transactions appear on the user's phone bill. Otherwise the entrant/participant may elect the right to interact or purchase a Recording after ticket purchase (with the information already stored serving to expedite those transactions). A further option would enable Bluetooth capability on the turnstile, kiosk and a user's device that could bypass a mobile carrier.

The ticket issuer at locations (101) then transmits the transaction data over a PC, other standard point-of-sale equipment well known in the art (not shown), the inventor's terminal design apparatuses [FIGS. 7(A)-(P)], and, if applicable, enables the a cellular phone device (308. 309) [that might be displaying a branded electronic ticket or itself serving as an electronic ticket (FIGS. 8(A)-(B))]. Cellular phone device enablement may also include integration with a turnstile reading system of FIG. 9. The ticket issuer's data might include information gathered from a charge card transaction that identifies the buyer/ticket holder and specifies the address (the charge card address or other address selected by the holder (102)) to which the Recording is to be sent, or the ticket seller inputs an election for direct charging by the mobile carrier, if applicable, to the Data Center (FIG. 2) (step 204). This transmission is done in real time, through the Internet, using industry standard protocols such as XML and is properly secured using one of many industry standard encryption methods.

Upon receipt at the Data Center, the transaction information is immediately loaded into the master system database (FIG. 3). The database system is capable of Recording a multitude of transactions involving a multitude of events simultaneously, while at the same time providing all of the required reporting and processing functions and maintaining both the physical and logical security of the information which is critical to the successful implementation of the method.

The preferred embodiment preferably uses an industry standard database system, e.g., Oracle, Microsoft SQL Server, IBM DB2, XML, etc., which is scalable, and an industry standard set of server hardware, which is also scalable to ensure that it can handle whatever transaction load is required.

In step (303) the Data Center (FIG. 3) checks if the transaction is valid. Invalid transactions are discarded (step 304). In step (305) the Data Center transaction is posted with database. In step (306) the transaction is backed up. Next, various data files containing statistical information are updated in the data base (307) to reflect the latest transaction(s).

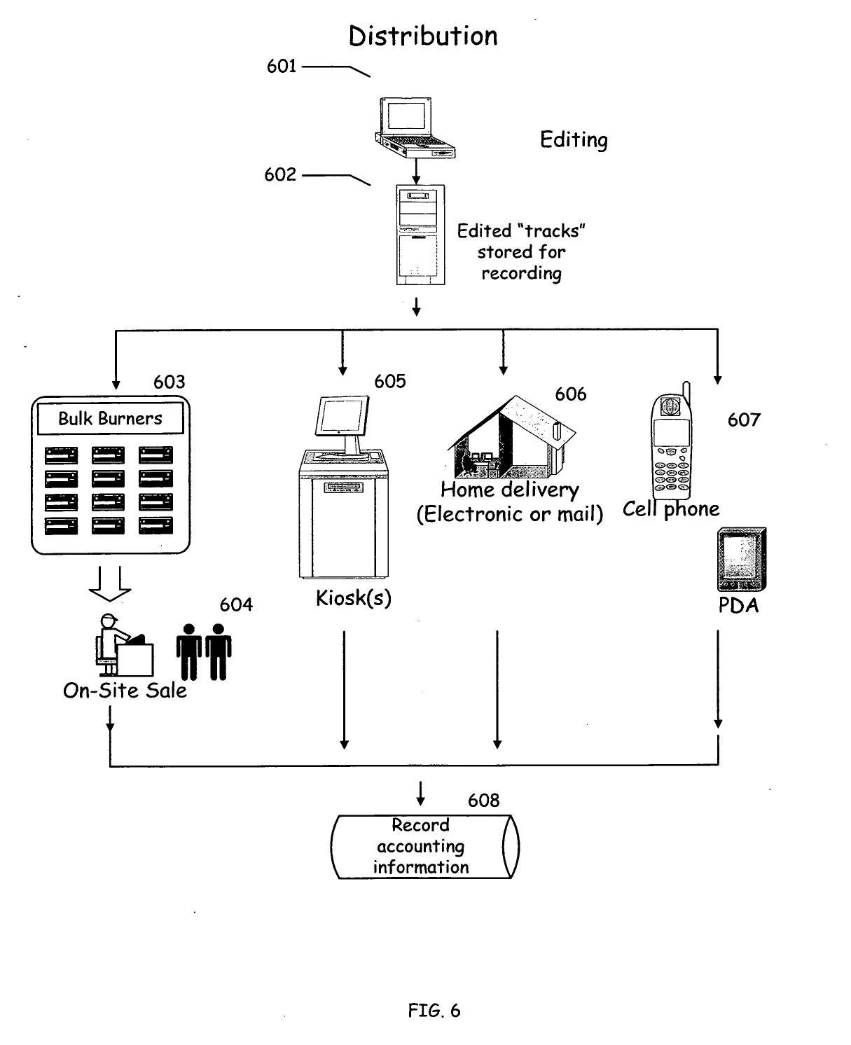

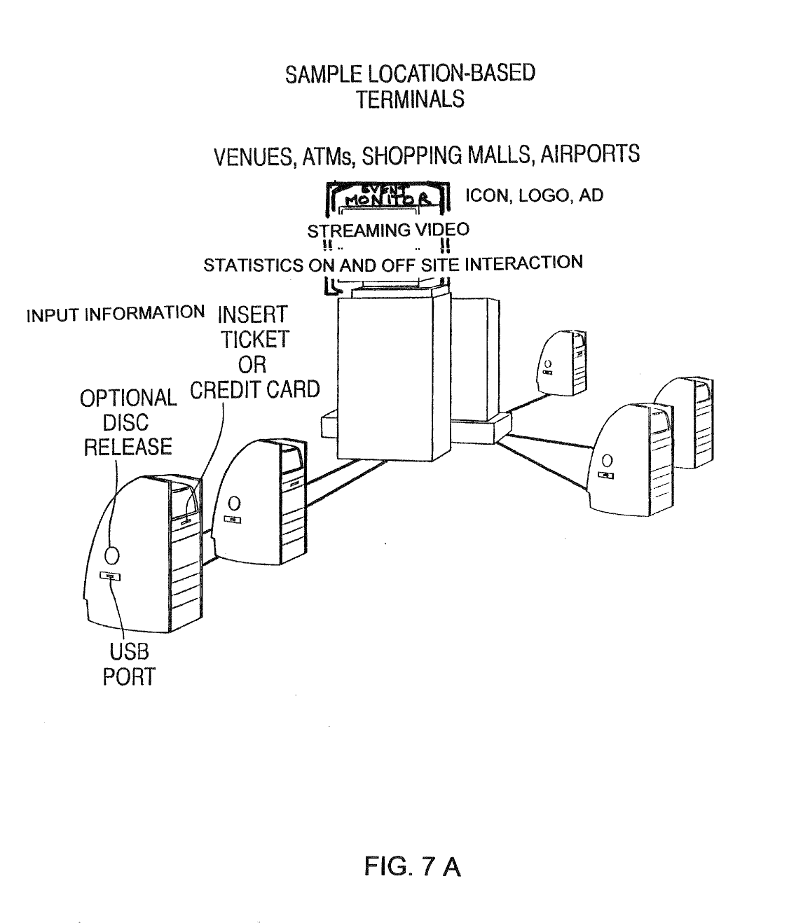

As indicated above, the Data Center (FIG. 3) also encompasses a series of Web servers (FIG. 2) providing as Web sites and/or Web services points of access for various interested parties to retrieve information required for their respective operations. FIGS. 5 and 6 show the process for generating the Recordings in fixed media of expression (CD, DVD, unfixed encoded format, e.g.) including on site using a suitable Recording subsystem (FIG. 1, 104, 105; FIG. 6, 601). During or immediately after the event, the Recording subsystem (FIG. 6) generates a Recording on an appropriate medium using preferably non-incremental methods. Recordings are made available to be retrieved on or off site on personal devices (PC's, cellular phone devices) and through enabled location-based terminals in fixed, digital or other encoded format (including though USB port or other methods) including the inventor's claimed enabled turnstiles and other apparatuses upon egress. This permits the attendees to wait until the event is already in progress or ends to decide if they want to participate, interact; or order event Recordings. Methods for regularly mailing Recording CDs and DVDs are also incorporated as are methods to integrate additional release offerings of labels, studios, artists, third-party distributors, sub-distributors and retailers including Web subscription sites.

As aforementioned, if tickets and Recordings are ordered for mobile enablement, display or transmission, the system will allow for direct billing by the mobile carrier or may integrate methods compatible with the carrier's billing systems such that charges will appear on the user's bill.

Booklets (if any) are prepared for the buyer together with labels that may be affixed to the Recording (FIG. 5, steps 501, 507) when ordered in tangible or disc form with additional branding, if applicable, containing the logos, icons, messages or ads of the sponsors. The completed Recording is delivered to the buyer (step 507) per the designated means of retrieval.

In steps 332, 333 the manufacturing details are sent to the Data Center and fulfillment center for accounting and statistical analysis. Using this data, in step 334 various statistical data bases are updated with the latest transaction(s). Steps 321, et seq. and 608, illustrate the final accounting process. In step 322 the transactions for the event are reconciled and finalized. In step 323 reports are generated. In step 324 the reports, data on interaction and voting, if applicable, and payments to various partners and sponsors, if applicable, are processed, calculated and transmitted. In step 325 temporary data in the central data base are cleaned out and the central data base is readied for the next event.

As discussed above, and illustrated in FIG. 1 if a user or buyer wants to pick up a live Recording directly at the venue upon completion of the event, authentication methods, including but not limited to DNA fingerprinting, thumb and iris scans, bar coding, cellular phone information or other uniquely identifying user information may be used (FIG. 6, 610). Referring to FIG. 6, the Recordings from the editing apparatus (601) are preferentially stored as tracks on servers (602) to enable users to purchase single titles, if desired, instead of whole concerts. Next, the Recordings are transmitted or may be “burned” on site by updated non-incremental CDR technology generating media (603) in bulk. The media (that may include DVDs, CDs, wired and cellular transmissions, etc.) are sold to either users or buyers (102), who have prepaid for the media when they were issued their tickets or alternatively to holders (102) who have not prepaid and pay for the media at a subsequent time including during or after the end of the event. For sponsors who select alternative compensation like dissemination of demographics on user options, the system also accommodates processing of this information (608). Integration occurs to process orders and interactive participation requests from those not in actual physical attendance over the Internet, Bluetooth and wireless networks, comprising the rest of the world (103). If ticket and/or Recording delivery takes place directly to a mobile phone, PDA, Blackberry, Treo, IPTV or other wireless device, commands refer billing to the carrier so that charges will appear on the user's bill (204). Bulk disc Recordings may also be sold by a clerk (604).

Alternatively, however, a kiosk or other enabled terminals (605) [apparatuses (FIGS. 7(A)-(P)) are provided that receive the Recording data from servers (ADD). The kiosk (605) is an automated kiosk, “vending machine”, enabled hospitality table in a nightclub/eatery, audience chair, venue turnstile, airport scanning machine, that receives, transmits, burns or spits out a Recording on demand when presented with authenticating information that may be information from a cellular phone, electronic ticket, other ticket or other uniquely identifying information the user. The kiosk or enabled terminal receives and/or prerecords the tracks on a selected media or encoded format and provides labels, branded booklets and other materials associated therewith, depending on format selected. The media and associated item(s) are then dispensed when the user/attendee inserts his ticket, his phone or other mobile device, or inputs other identifying authentication information into the kiosk (FIG. 5, steps 506, 507). Alternatively, the kiosk receives the ticket or other input information from the user/orderer and, in response, starts the burning or reproduction of the media or takes order for the mailing or desired home electronic retrieval. In the instance of mobile phones and portable devices including enabled hand-held music players, the kiosk can transmit a Recording directly to the device (FIGS in 7). In this configuration, the user may be given the choice of customizing his Recording by selecting specific songs from the concert, for example, (instead of the whole event) that should be transmitted or burned on the media, their sequence, etc., “best of the tour’ tracks and narration tracks, e.g. This will be the preferred method if a kiosk is in the form of a patron's table or audience seat at an eatery, nightclub or showcase (FIGS. in 7).

Orders to interact or participate with an event or order Recordings from remote consumers can also be taken at location based enabled turnstiles including ATM machines installed at banks, airports, malls, other public venues and from personal portable devices including PCs, PDAs, Blackberry, Treos, IPTV devices and mobile phones. In the alternative, a user may “plug in” a phone or hand held device that can receive a transmission of the Recording and store it for future play or upload (FIGS. in 7).

A user (102) who has not prepaid for the Recording may also obtain one using the kiosk (FIGS. in 7) and charge a transaction to his credit card, mobile phone carrier or by using other payment means. Electronic tickets that are read by the enabled turnstiles, and enable downloads directly to mobile devices will preferentially be billed directly by the mobile carrier with charges appearing in the user's bill.

The kiosk (605) may also deliver a Recording as a data file that becomes available for downloading by the user (to a PC, PDA, portable music player, or other phone device) through a data port (such as USB port) on the kiosk (605).

Finally, after the event is finished, a Recording can be delivered or distributed electronically as a digital file to a third party distributor including a mobile carrier, online subscription site or the home (606) of the user and the location based point of sale site may be bypassed. Communications between the various elements of the systems can be implemented over wired or wireless networks. Typical wireless networks that may be employed include Wi-Fi, Bluetooth, etc.

The ticket holder/Recording buyer (102, 103) can from any terminal, for example, check on the status of his order, the results of a staged competition or tournament and perform a limited range of functions, such as changing the delivery address for his order, order additional Recordings, or order that promo information of upcoming concerts and other future Recordings be sent to him.

Similarly, the entertainment companies, record labels, sports teams, conference and event sponsors, can check, in real time, to see how many Recordings for an artist, celebrity or marketed product have been requested and sold for any event, track the royalty and other payments through the system, and, for example, receive survey responses from those who elected to participate in [talent/product] voting and competitions, If the buyer opts to allow dissemination of other demographic information including, for example, order promos, tickets for upcoming events or Recordings and other merchandise, the system will accommodate those requests. By integrated methods, it will also allow for ordering special purchase options of “best of’ releases, director's cuts, narration tracks, single tracks and compilations emanating from the live event.

The Data Center (FIG. 2) maintains security and confidentiality through the system. The entertainment entities and “Partners” are issued specific password credentials which are authenticated through standard industry techniques (FIG. 4, steps 403-408). In the case of the ticket holder/Recording buyer or conference attendee (who may have been issued a free promotional pass), the ticket or pass number along with information not printed on the ticket, such as his billing address or other identifying information (mother's maiden name, e.g.) is used for verification before he can gain access to the privileged areas of the processing Website (403).

As shown in FIG. 1, in addition to users, holders and/buyers (102, 103), other entities may also have access to the Data Center, including revenue participants (406-408) that may include several Partners and/or program sponsors. In addition, specialized servers may also be provided as part of the system. For example, a server (203, 205) is used to determine fees and royalties for the various Partners (406-408). The server provides standard accounting services. These servers can communicate with each other and with other components of the system through standardized networks, such as the Internet.

Of course, the whole purpose of the system is to organize, manage and run more and secure live events (including air line travel), enable interactive capability, and make more content available and quickly to patrons. This will help expand the promotional and geographic influence of virtually any event benefiting the copyright holders and sponsors by fulfilling impulse buys both from those physically in attendance and other interested persons throughout the rest of the world. As part of this process, buyers (102. 103) can buy the right to interact, to bet, to participate in contests, receive or buy Recordings of the event and other products and services associated with the event or tie-in items if made available. These materials may be made available immediately at a point of sale station (or store) (604) in any one or all of multiple formats as discussed in detail below and shown in FIGS. 6 and 7. The event is recorded and edited by on-site editing equipment (601) to provide the immediate Recording at a station (603-607). For CDs and DVD's, non-incremental or other burning technology compatible with updated standard CDR technology is preferentially to be used.

In addition, or alternatively, the event is recorded by digital Recording equipment (104). The recorded data inclusive of editing and balancing data as may be electronically converted from an audience reading to a disc/digital reading (601) is then sent to an offsite manufacturing site (FIG. 5) where the Recordings are generated (on CDs, DVDs, “encoded only” and other similar media) and then packaged and distributed to the users (102, 103), as discussed in more detail below and illustrated in FIG. 5. Manufacturing instructions (FIG. 1, step 105; FIG. 5) to both sites [station and manufacturing site] are provided by the Data Center (FIG. 2). Moreover, the Data Center receives inventory and accounting information (108, 109) from both sites.

Details of how requests for transactions and information are handled by the Data Center (100) are provided in FIG. 3. A request is received by the Data Center (100) in step (200) via the Internet. In step (210) a check is performed to determine if the request is a special request for information (available only to certain subscribers and partners). If it is not, then in step (212) information is retrieved and sent to the requester indicating what services are available, including lists of future events for which tickets, Recordings, and/or other items can be purchased. Lists of other items related, for example, to Recordings from past events, may also be displayed. In step (214) a request for tickets, Recordings or other items is received from a user (10). The request is processed, the user (10) is issued a ticket and the resulting transaction is processed as described in the flow charts of FIGS. 2, 3 and 4.

If in step (402) a special request is identified, then in step (404), the requester is asked to provide a password and the password is validated. If the requester is identified in step (404), then in step (406) he is directed to a special partner Website where he can access data on various events, including their status, number of orders for received for the events, fees collected, royalties due to the partner, etc. In step (406), data related to the partners is updated in the Data Center (408), if necessary.

If the requester is identified as a registered buyer, then in steps (402-405) the buyer logs in and is directed to a buyer site. At this site, the buyer is allowed to check on the status of his order, he is allowed to change his order, provide information for shipping, retrieval, etc. The information or changes entered by the registered buyer is stored in the Data Center (FIG. 2).

After a particular event has concluded, the Data Center sends to the fulfillment house (FIG. 5) information specifying the number of complete and derivative or special order Recordings to produce and the addresses to which those designated to be mailed, should be mailed.

Off site Recording is performed by a manufacturing station or site (FIG. 5). As shown in FIG. 5, after the event, the performance data is received in step (501). This data may be streamed or may be sent electronically in a batch. Alternatively, the data may be recorded on a data storage medium and sent to a site (502).

In step (503) the data is edited. Editing may incorporate the inventor's previously disclosed method of digitized conversion from an audience balanced to disc balanced reading. In step (504) the data is prepared for Recording on a master. In step (505) the data is optionally encrypted, and, if desired, a unique watermark is added for copy protection along with any additional digital rights management methods. In step (506) multiple copies are made from the master by burning or other means. In step (507) labels that may incorporate brands, logos or ads of sponsors are applied to the media and the labeled media is boxed and packaged together with other materials, such as booklets, pictures, etc. In step (508) the packaged media are shipped.

In step (508) additional copies of the Recordings are made, if necessary. In step (509) a production document is generated. In step (510) the data files at the Data Center (FIG. 2) are updated to reflect the Recordings produced and shipped.

The Data Center also handles all tasks of reporting and accounting for copyright and other participants and generates detailed statements and accounts including the amounts of statutory and contractual royalties (108, 109).

To summarize, a Recording emanating from or associated with a live event or the right to interact with an event is ordered before, during or after the event by a ticket holder who has attended the event or by an off-site buyer or participant by any available means including, but not limited to, by using an appropriate Website, PC, located-based enabled termination or enabled hand-held device including an IPTV, PDA, Blackberry, Palm, Treo or cellular telephone.

While the specific embodiments have been illustrated and described, numerous modifications come to mind without significantly departing from the spirit of the invention and the scope of protection is only limited by the scope of the accompanying claims.

1. An apparatus for providing at least one of pre-authorized entry and security methods at public event venues such as for a concert, sports event, film, stage event, showcase event, arts-related event, theme park, movie house, production set, lecture, conference and travel (common carriers, airports, etc.) comprising a plurality of entry control terminals that control the entrance of attendees in response to their presentation of a pre-authorized entry means without the need for a physical paper ticket.

2. The apparatus of claim 1 further comprising a station to purchase, order and retrieve tickets, merchandise, products, services and Recordings of one of, emanating from, associated with and offered for sale at an event, venue or travel terminal including in encoded format for direct transmission to an attendee's mobile device.

3. The apparatus of claim 1 wherein said pre-authorization entry or security means include hand-held devices selected from a group consisting of mobile phones, personal computers, personal data assistants, Blackberrys, Treos, music players, media players, etc., and wherein said entry control terminals and said station include means for reading and processing information from or displayed by said held-held devices.

4. Means wherein interactivity with a live event including rating, voting, input of question and answers, and order of event Recordings, products and services is enabled by one of mobile phones, personal computers, personal data assistants, Blackberrys Treos, music players, media players, other electronic devices and uniquely identifying information of a consumer, participant or user who may be located on or off site from where the event takes place.

5. The apparatus of claim 1 wherein said entry control terminals respond to the presentation of at least one of a DNA sequence, a fingerprint, a credit card, a credit card authorization, social security number, audience seat number, bar code, a previously ordered ring tone/music download, mobile phone, Blackberry, personal data assistant, Treo, mobile or any other phone number, a cellular phone device's electronic identification number, a user's subscription account, Internet address, smart card, registration and entry pass.

6. The apparatus of claim 1 further comprising at least one of a recording device generating a Recording emanating from or associated with the event and a transfer device including a receiving device that receives a Recording and a transmitting device arranged to transmit said Recording by one of a land link, direct Internet link, e-mail, mobile phone, wireless, Bluetooth and other link using an encoded transmission of said Recording, said Recording being transmitted to a remote location, address or device associated with, or directed by a respective attendee.

7. The apparatus of claim 5 further comprising an order taking device adapted to receive a request for said Recording, said order taking device initiating sending said Recording to a party making said request or authorized to receive said request in one of a hard copy and an electronic copy formats.

8. The apparatus of claim 1 wherein the event being attended is viewed from an individual seat, a table, seats surrounding a table, and other intelligent terminal or kiosk, further comprising an electronic device that may be operated by at least one of said attendees, of that receives an input from the respective attendee(s) including without limitation by the attendee's attachment of a mobile phone, PDA, Blackberry, Treo, music player or other storage device, insertion of a ticket or electronic ticket, or other input being selected from one of a participation response, a rating, vote, question or comment associated with the event, a request for a Recording associating with said event or other products and services.

9. The apparatus of claim 7 further comprising means to electronically process and charge for at least one of a food order, beverage order, checks, parking, orders for event Recording, requests for interaction with the event and purchases for other Recording and merchandise.

10. The apparatus of claim 1 further comprising a remote display presenting at least a part of said event, or an occurrence associating with it, and an input device receiving an input from one of said attendees at a remote location indicative of at least one of an electronic participation related to the event and a request for a Recording, said input device generating an output to a processor indicating of said input.

11. The apparatus of claim 9 wherein said input device is a mobile phone, PDA, Blackberry, Treo, etc.

12. The apparatus of claim 9 wherein said output device transmits said Recording to one of a land, an electronic address and wireless phone address associated with or directly by one of the attendees.

13. The apparatus of claim 8 further comprising input means that process a request from one not physically attending for at least one of an event Recording and rights to interact with the event.

14. The apparatus of claims 8 further comprising means for direct charging for at least one of an entry to attend an event, to interact with an event and purchase an event Recording by at least one of a mobile phone and telecommunication carrier servicing the device and party authorizing the charge.

15. The apparatus of claim 9 further comprising an output device that transmits an event Recording to one of a land, an electronic address or wireless phone address associated with a non-attendee.

16. The apparatus of claim 1 further comprising a security device including a scanner that scans the attendees and items on the person of attendees as they enter or leave the event or terminal of travel said security device generating an output indicative of said scan.

17. The apparatus of claim 1 further comprising a Recording device receiving information from the scan and generating a Recording responsive to said scanning.

18. A method of controlling access to and egress from an event, venue, public, or private space or travel terminal including, for example, concerts, sports stadiums, theaters, conferences, lectures, airports, etc., comprising: (1) generating identifying information as to the date and time of the event, and venue; (2) associating said identifying information and identifying information identifying an attendee using at least one of a land-based address, an Internet address, electronic identification number, mobile phone number, credit card, electronic social security number, bank account, PDA, Blackberry-type device an address from which said attendee placed a prior merchandise order or authorized the processing of a transaction, and downloaded data or information supplied by the entry authorizer including bar code, registration and admitting pass and credit card authorization; and providing an access control device at a site related to said event, venue or space incorporating a security device that scans the attendees as they enter or leave the event, venue or space, with said security device generating an output indicative of said scan.

19. The method of claim 17 further comprising presentation by said attendee of a portable device to said access control device, said portable device providing data based on said identifying information associated with data supplied by the entry authorizer to said access control device.

20. The method of claim 18 further comprising: analyzing said data by said access control device; and providing access to said attendee if said data indicates that said attendee is associated with said identifying information.

21. The method of claim 18 further comprising obtaining a request from said attendees to order event Recordings and merchandise offered at the location; and processing said request.

22. The method of claim 17 further comprising providing at a point of issuance of one of an entry pass, registration pass, placed bet, physical ticket or electronic ticket to an event, venue, mode of travel, etc., (to include personal computers, mobile devices, phones, etc.) said point of issuance further receiving from attendees an order for one of an option to interact with the event, and an event Recording, said order to be executed during or after the event.

23. The method of claim 17 where orders from those in physical attendance and placed after issuance of an entry pass, registration pass, placed bet, physical ticket or electronic ticket are integrated.

24. The method of claim 21 further comprising receiving by said point of issuance orders from persons not in physical attendance at the event wherein interactive responses and event Recording orders from are integrated with orders from attendees.

25. The method of claim 17 further comprising integrating orders from those not in physical attendance with orders from attendees placed at locations and on devices other than the points of issue of tickets.

26. The method of claim 22 wherein said point of issuance receives said orders over one of wired and wireless networks.

27. The method of claim 24 wherein the orders for event Recordings or to interact with an event from at least one of an attendee and a non-attendee and placed external to the point of entry issuance occur over wired or wireless networks.

28. The method of claim 27 further comprising triggering digital encoded transmissions to one of designated electronic addresses including e-mail addresses, subscription Internet sites, other designated Web sites, mobile phones and other hand-held devices said transmissions including event Recordings generated in response to said orders.

29. The method of claim 24 further comprising triggering in response to orders for event Recordings digital encoded storage of said event Recordings onto one of mobile phones, hand-held music and media players, personal data assistants, Treos and Blackberry-type devices.

30. The method of claim 25 further comprising receiving uniquely identifying information of an event Recording purchaser and using said identifying information for one of a direct transmission of the Recording and authorized retrieval of the Recording in encoded format including mobile telephone numbers, PDAs, Blackberry numbers, credit card, Internet account numbers, subscription numbers, subscription site, smart card numbers.

31. The method of claim 27 further comprising using at least one of encryption, watermarking, digital rights management and bar coding to secure data transmissions.

32. The method of claim 27 further comprising generating corresponding ring tones and ring back tones in mobile phones using said event Recordings.

33. The method of claim 27 integrating technology that places an outside file created by a third party or entity on the display of an electronic mobile device or file.
